(19) United States
(12) Patent Application Publication
(10) Pub. No.: US 2018/0279735 A1
(43) Pub. Date: Oct. 4, 2018

(54) CLOSURE DEVICE ASSEMBLY FOR A PIECE OF LUGGAGE

(71) Applicant: VICTORINOX AG, Ibach (CH)

(72) Inventors: Tillman PAUL, Stoos (CH); Carsten KULCKE, Schwyz (CH); Antonio DI GIOVANNI, Altena (CH)

(73) Assignee: VICTORINOX AG, Ibach (CH)

(21) Appl. No.: 15/546,120

(22) PCT Filed: Feb. 25, 2016
(86) PCT No.: PCT/EP2016/053992

§ 371 Date: Jul. 25, 2017

(30) Foreign Application Priority Data
Feb. 26, 2015 (EP) 15 156 747.6
Sep. 11, 2015 (EP) 15 184 806.6

(51) Int. Cl. A45C 13/10; A45C 5/03; A45C 13/18; E05B 65/52

(52) U.S. Cl. CPC A45C 13/103; A45C 5/03; E05B 37/0034; E05B 65/52; A45C 13/18

(57) ABSTRACT

Closure device assembly (1) for a piece of luggage (5) with a zipper (60), the assembly (1) comprising a zipper slider (15) for said zipper (60), an engagement element (10) for arrangement on a first body portion (51), a buckle element (11) for arrangement on a second body portion (52) and pivotable for engagement with said engagement element (10). The assembly (1) further comprises a bolt (12) with a bolt biasing member (130) being attached to said bolt (12). Said bolt (12) is moveable between a locking position, in which said bolt (12) engages with the zipper slider (60), the latter being in closed position, and a release position, in which said zipper slider (15) is released. The buckle element (11) is adapted to cover, when engaged to said engagement element (10), said bolt (12) and said engagement section (150) of the zipper slider (15) in said closed position.

### TECHNICAL FIELD

The present invention relates to a closure device assembly for a piece of luggage, in particular a suitcase, and to a suitcase with such a closure device assembly.

### PRIOR ART

It is known to lock pullers of a zipper in a lock as shown in US 2011/0186397 A1. The zipper pullers, i.e the pull tabs, are engaged in dedicated slots in the lock. The slots are arranged spaced to one another in the direction of the zipper. Such locks have the drawback that a puller may be inserted in the wrong slot, whereupon the lock must be opened for placing the zipper puller correctly. Also, the locked puller may rather easily be broken to remove them from the slider, whereupon the slider is free to open the zipper. Moreover, the lock is easily accessible for manipulation and therefore not as secure as desirable.

Finally, in case of a suitcase with hard shells, the closed zipper is a further weak spot which may be opened by means of a tool as simple as a pen.

### SUMMARY OF THE INVENTION

One of the objects addressed by the present invention is to provide an improved closure device assembly as mentioned in the preamble of claim 1.

This object is achieved by the closure device assembly of claim 1. Accordingly, a closure device assembly for a piece of luggage, preferably a suitcase, most preferably a hard shell suitcase, is suggested. The suitcase may be a frameless hard shell suitcase. The piece of luggage has a first body portion, a second body portion, and a zipper, said zipper being arranged between said first and second body portions. Furthermore, the closure device assembly comprises:

at least one engagement element adapted for arrangement on said first body portion;

at least one buckle element adapted for arrangement on said second body portion, said buckle element being adapted for pivotal motion between an open position and an engagement position such that, in said engagement position, said buckle element is in contact, preferably in engagement, with said engagement element, said pivotal motion being about an axis that extends substantially parallel to said zipper, and

at least one zipper slider adapted for operation of said zipper and having at least one engagement section for engagement with said engagement element and/or said buckle element.

Moreover, the closure device assembly comprises a locking device for locking said engagement section of said zipper slider, when said zipper slider is in a closed position.

In order to achieve the above object, said buckle element further comprises a cover element and is adapted to cover in a closed positon of the closure device assembly with said cover element at least part of the locking device and a part of the zipper slider, preferably said engagement section of the zipper slider in said closed position.

Preferably, only a part of the zipper slider is covered by the cover element in closed position.

Preferably, the zipper puller itself is not directly engaged with said engagement element and/or said buckle element, only via the slider. Accordingly, the engagement section is not part of the zipper puller but part of the slider. The term “slider” has to be understood as the element that brings the zipper parts into and out of engagement, while the puller is the tab that is attached to the slider for easy manual operation of the zipper.

The present invention is based on the insight that the closure device assembly may be equipped with a buckle element that covers, with its cover element, the sensitive parts of the closure device assembly. Thereby the security of the closure device assembly is increased and the locking device and the engagement section of the zipper are protected from third-party access. Moreover, in case of hard shell luggage pieces the closure device assembly keeps the hard shell body portions together, even if the closed zipper is broken. Accordingly, in particular for hard shell luggage pieces, the closure device assembly provides further security.

Preferably, the assembly is designed to allow for engaging the sliders after closing the buckle element.

Preferably, the assembly is designed to allow opening the zipper without opening the buckle element.

Preferably, the engagement section is insertable into the closure device assembly in the direction of the zipper.

In some embodiments, the engagement section may be integral part of the zipper slider. The engagement section and the slider may therefore be single-piece element. Here, the engagement section has to be distinguished from the zipper puller of a conventional zipper, the puller being hinged to the slider. The engagement of the slider itself and not of the puller provides additional security as the connection between the slider and the puller is a weak link. In the context of these embodiments the slider is inserted into the closure device for engagement there with at least its engagement section, preferably in the direction of the zipper.

In some embodiments, the engagement section may be attached to the zipper slider, e.g. it may be the zipper puller or another part attached to the zipper slider.

In some embodiments, the locking device further comprises at least one bolt adapted for releasably locking said zipper slider and a bolt biasing member being attached to and biasing said bolt, wherein said bolt is moveable between
a locking position, in which said bolt engages with an engagement section of the zipper slider for locking said zipper slider, when said zipper slider is in closed position; and
a release position, in which said zipper slider in said closed position is released,

wherein said buckle element is adapted to cover, in said engagement position, with said cover element at least said bolt and said engagement section of the zipper slider in said closed position.

The term “body portion” refers to a part of the piece of luggage, preferably to a half-shell of a suitcase.

The term “zipper slider being adapted for operation of said zipper” means that the zipper slider may be brought into engagement with rows of teeth arranged along at least parts of an edge of the body portion. The tooth elements may then be made to interdigitate for linking the rows, whereby the opening between the body portions is closed.

The term “the pivotal movement being about an axis that extends substantially parallel to the zipper” means that the buckle element is arranged on the first body portion such that its pivot axis extends substantially parallel to the tooth rows of the zipper. Accordingly, the buckle element is pivotable to extend over the zipper to contact the engagement element arranged on the second body portion, whereas the first and second body portions are spaced from one another over said zipper.

The term “adapted for arrangement on a body portion” means that the buckle element and the engagement element are designed to be arranged on the respective body portion such that the zipper slider may be locked in the closed position by means of the bolt, wherein said bolt and at least the engagement section of the zipper engaging with the bolt may be covered by the buckle element. This may be done by bolting, gluing, screwing, or integrally forming them into the body portions.

The term “closed position” is the position of the zipper slider where it can be locked by the locking device, i.e. where it extends into a designated gap of the closure device assembly. Typically, this is the position where the zipper ends. With reference to the closure device assembly, the term “closed” refers to the closed state of the assembly.

The term “engagement position” is the position of the buckle element where it contacts the engagement element. Preferably, the buckle element engages in a hook-connection with the engagement element.

The term “open position” refers to the position in which the buckle element is not in contact with the engagement element. In this position, the zipper slider is preferably not locked and may be freely moved along the zipper for opening/closing the piece of luggage.

The term “bolt being adapted for releasably locking said zipper slider” means that the bolt, when in locking position, mechanically blocks the movement of the zipper slider. Preferably, the bolt extends and moves angular or rectangular to the direction of the zipper and may extend into a recess, a lug, a ring, or a loop of the zipper slider. Preferably, the bolt may be moved from the locking position into the release position whereby the engagement of the bolt into the engagement section of the zipper slider is lifted.

The term “adapted to cover, in said engagement position, at least part of the locking device and said engagement section of the zipper slider in said closed position” means that the buckle element covers with a preferably plate-like cover element the sensitive region where the engagement section is locked by the locking device, whereby unauthorized access to the locking device is prevented. Said part of the locking device that may be covered may, in some embodiment, be the bolt that catches the zipper slider.

In some embodiments, said bolt biasing member biases said bolt in said release position. This ensures that the closure device assembly only locks when the bolt biasing member is activated, e.g. if said buckle element is in contact with said engagement element, wherein the engagement element has means for activating the bolt biasing member. Accordingly, this feature helps to prevent faulty operation of the closure device assembly.

In other embodiments, said bolt and said bolt biasing member are attached to said buckle element.

In some preferred embodiments, said bolt and said bolt biasing member are attached to said engagement element. This design has the advantage that said buckle element that is moved a lot is rather light and said bolt, being arranged on said engagement element, is always properly oriented with respect to the zipper slider when in closed position.

In some embodiments, said bolt is arranged on a pivotable bolt lever arm, preferably a single-lever arm, wherein said bolt biasing member biases said bolt lever arm in the release position. This allows a compact and mechanically stable construction of the closure device assembly.

In some embodiments, the closure device assembly further comprises an actuation device, wherein said actuation device is adapted for moving said bolt against said bolt biasing member from said release position into said locking position upon closing the closure device assembly, i.e. when the buckle element is brought into contact with the engagement element.

It is preferred to arrange the actuation device either on said engagement element or said buckle element, whichever does not carry the bolt. In some preferred embodiments, said actuation device is attached to said buckle element. The actuation device may be designed for actuation the bolt biasing member, i.e. for shifting the bolt lever arm from the release position into the locking position, upon closing the buckle element, i.e. when the buckle element contacts the engagement element.

In some embodiment, the actuation device is a latch element, arranged in the buckle element such as to be shiftable between the initial and the actuation position. The latch element may be moved by a push element and biased by a biasing member biasing the locking device.

In some embodiments, said actuation device comprises an own actuation biasing member for biasing said actuation device in an actuation position such that, upon closing the closure device assembly, said actuation biasing member overrides said bolt biasing member and pushes said bolt from said default release position into said locking position. Moreover, said actuation device may be adapted for being moved, preferably pivoted, against said actuation biasing member from said actuation position to an initial position. This motion is preferably controlled by a push element which has a lock. This also allows for releasing the locked zipper sliders without fully opening the closure device assembly.

Accordingly, the actuation position is the default position of the actuation device into which it is forced by its actuation biasing member. The actuation device may be brought into the initial position by e.g. pivoting the actuation lever arm against the action of the actuation biasing member, e.g. by means of the push element.

In some embodiments, said buckle element has a first engagement portion and said engagement element has a second engagement portion, the first and second engagement portions being adapted for mutual engagement. The engagement is preferably a positive-lock engagement like a hook-hook connection.

In some preferred embodiments, said buckle element is designed as a toggle clamp adapted for clamping the engagement element and therefore said first and second body portions to one another. The toggle-clamp design may comprise at least or exactly two pivot axis. Preferably, a double hinge lever is used to connect a base element which is on the body portion and the cover element to one another.

The first engagement portion may have a bent, hook-like edge region adapted for encompassing an edge of the engagement element. It may comprise an engagement web.

Preferably, the cover element of the buckle element is a plate-like element with inwardly facing rims that extend from the plate towards the piece of luggage such that the buckle element forms a covered space for installation of further parts of the closure device assembly such as, e.g., the actuation device. The rims or side walls may have recesses where the push element, the zipper and/or the engagement section(s) of the zipper slider(s) extend into the gap.

In some embodiments, the closure device assembly further comprises the push element for moving said bolt from said locking position into said release position. Accordingly, the push element may be pushed by the user while the closure device assembly is closed and the zipper slider(s) are locked. Upon pushing the push element the zipper slider(s) may be released and the slider(s) may be moved to open the piece of luggage.

In some embodiments, said push element is a push button arranged on said buckle element. Thereby the push button is well accessible by the user. Said push button is preferably arranged on the cover element opposite said first engagement portion, wherein the closed closure device assembly is adapted for moving said actuation device from said actuation position into said initial position by means of pushing the push element, whereupon said locking device is moved into the release position. In some embodiments, the bolt is moved thereby from said locking position into said release position.

Preferably, the push element is adapted to push, upon pushing on the push element, onto the bolt lever arm to bring it into release position. Accordingly, by means of the push element, the closure device assembly in closed position is adapted to bring locking device into release position without moving the cover element. The moving bolt lever arm may further be adapted to push then onto said actuation device for bringing the locking device into release position and the actuation device into initial position.

In some embodiments, the push element may be locked by a lock, e.g. a number lock, a key lock, or the like. Furthermore, a Transportation Security Administration (TSA) lock may be provided in some embodiments.

In some embodiments, said bolt and/or said engagement section of the zipper slider are/is formed, preferably provided with a slanted surface, such that the zipper slider that is moved to close the piece of luggage pushes said bolt, preferably against said actuation biasing member, into said release position. Accordingly, the buckle element may, when arranged on the piece of luggage, be closed before the zipper sliders are moved to closed position. For example, the piece of luggage may be filled with items; then, the body portions may be pivoted to one another. If the content of the piece of luggage is abundant, the user may have to press the body portions toward one another. The preferred embodiment with the toggle-clamp design then allows engaging the buckle element and the engagement element such that the position of the two body portions is secured. In a next step, the zipper may be closed with both hands, if necessary, and then the buckle element may be completely closed, i.e. the buckle element may be pivoted along the toggle motion to come into parallel arrangement with the surface of the piece of luggage, or vice-versa. If the toggle-clamp is closed before the zipper slider is in closing position, the zipper slider may simply be pushed into a gap under the buckle element such that it presses on the slanted surface of the bolt, whereby the bolt is moved out of the locking position into the release position and the engagement section may be fully inserted into the gap. The bolt is then forced back into locking position by the actuation device. Accordingly, the toggle-clamp design helps to close the piece of luggage step wise and with leverage as the toggle-clamp design allows for addition leverage upon closing the closure device assembly.

If the bolt and the bolt biasing means are arranged in the engagement element, the zipper slider can (but doesn't have to be) locked before the toggle-clamp designed buckle element is closed. It is, however, preferred that the default position of the locking device is the release position.

In some embodiments, the closure device assembly comprises at least or exactly two zipper sliders working in opposite directions on said zipper, wherein, preferably, the closure device assembly comprises at least or exactly one bolt for each zipper slider. Then the zipper sliders may be brought into closed position from different directions of the zipper.

In a preferred embodiment, the locking device and the actuation device each comprise two single-lever arms. The two lever arms of the locking device being preferably hinged to the same bolt lever pivot joint, and the two lever arms of the actuation device being preferably hinged to the same actuation lever pivot joint. This allows a compact and reliable use of the device.

In another preferred embodiment, the actuation device is a latch element that may be moved in the buckle element. In some embodiments, the latch element may be a single-piece element. In some embodiments, the latch element may have a contact portion for contacting the security device, preferably the two two-arm levers.

In some embodiment the latch element may be arranged and configured to be in contact with the push element, if any, such that a push action onto the push element translates to a movement of the security device from a locking position into a release position. The push element in actuation position may be moved back into its initial position through at least one biasing member. This biasing member may be the biasing member of the security device and/or a biasing member of the push element itself.

In some embodiments, the closure device further comprises a counter plate with at least one, preferably two support portions, wherein the counter plate is arranged and designed such that each support portion supports one zipper slider in closed position against force applied through the cover element onto the zipper slider. This is particularly relevant when closing the cover element while the zipper sliders are in closed position as then the engagement process for engaging the engagement section of the slider may lead to a force applied through the cover element to the slider. If no support element is arranged, the slider may avoid this force by moving away which would avoid the engagement of the slider.

In some preferred embodiments, the zipper slider comprises a pull element, wherein this pull element comprises two parts, i.e. it is formed as a two-piece element, the two parts being hinged to one another, preferably via an axle. The pull element is designed such that the first and second parts are pivotable around an axis with respect to one another from a flat configuration to only one side into an angled configuration. Accordingly, the flat configuration is defining a stop of the hinge movement to one side. Such a pull element design allows pushing the flat pull element to apply a shifting force onto the slider to bring it into the closed position, which may require some force as there is an engagement process involved if the cover element is closed. Preferably, in the angle configuration, an angle between the first and second part is 90° or more.

In some embodiments, the zipper is a double layer coil zipper with at least four rows of teeth, two arranged directly above one another to form pairs, wherein the pairs are arranged opposite one another to form two zipper sections above one another. The pairs of teeth may be formed from one coil.

In some embodiments, the engagement element comprises at least one ramp element with an inclined surface for guiding a releasing movement of the cover element. This extra guidance avoids that the cover element runs against items that are arrange in front of the closure device assembly as it directs the movement of the cover element upwardly.

The present invention also relates to a piece of luggage, in particular a suitcase like a hard shell suitcase, preferably without a frame construction, comprising a first body portion, a second body portion, and a zipper, the zipper being arranged between the first and second body portions, the piece of luggage or suitcase comprising a closure device assembly as described herein, wherein the at least one engagement element is arranged on the first body portion and the at least one buckle element is arranged on the second body portion.

The embodiments described herein are illustrative of some of the applications of the principles of the present invention. Numerous modifications and/or combinations of features that are individually disclosed may be made.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a suitcase with a first embodiment of the closure device assembly according to the present invention comprising an engagement element and a buckle element with a push element;

FIG. 2a shows the locked closure device assembly according to FIG. 1 with a locking device of the engagement element in locking position and an actuation device of the buckle element in actuation position such as to lock zipper sliders and a push button in default position;

FIG. 2b shows the locked closure device assembly according to FIG. 2a with the push button in depressed position, whereby the locking device is brought into release position and the actuation device is brought into initial position such that the zipper sliders in closed position are unlocked;

FIG. 2c shows the closure device assembly according to FIG. 2b with the zipper sliders moved away from the closed position;

FIG. 3a shows the locked closure device assembly according to FIGS. 1, 2 in open position;

FIG. 3b shows the buckle element, including the actuation device in actuation position, in engagement position with the locking device being in release position, while the locking device an the actuation device are in contact with one another;

FIG. 3c shows the actuation device forcing the locking device in locking position;

FIG. 3d shows the zipper slider pushed into a gap between the buckle element and the engagement element, with the slider pushing away the bolt of the locking device;

FIG. 3e shows the bolt according to FIG. 3 snapped back into locking position;

FIG. 4a shows the locked closure device assembly according to FIGS. 1, 2, 3 in open position, the buckle element and the engagement element being pushed toward one another, the zipper sliders not being in closed position;

FIG. 4b shows the locked closure device assembly according to FIG. 4a but not showing the cover element for clarity, the zipper sliders being pushed into closed position;

FIG. 4c shows the locked closure device assembly according to FIGS. 4a,b with the buckle element, including the actuation device in actuation, being in engagement position and the locking device being in release position, while the locking device and the actuation device are in contact with one another, and the zippers sliders being in closed position;

FIG. 4d shows the closure device assembly in closed position;

FIG. 5a shows the push element in default position according to FIG. 1 with a lock in open position;

FIG. 5b shows the push element according to FIG. 5a in depressed position with the lock being in open position;

FIG. 5c shows the push element according to FIG. 5a in default position with the lock being in locked position, whereby the push element is blocked, and with a TSA lock in closed position;

FIG. 5d shows the situation according to FIG. 5c with the TSA lock being in open position;

FIG. 5e shows locking pin of the closed lock freed by the TSA lock in open position;

FIG. 6 shows FIG. 4a from the inside;

FIG. 7 shows a cross section of a lock for locking the buckle element;

FIG. 8 shows the suitcase with a second embodiment of the closure device assembly according to the present invention comprising an engagement element and a buckle element with, a cover element and a push element;

FIG. 9 shows the closure device assembly according to FIG. 8 without the cover element such that inter alia a base element, a connecting element connecting the cover element and the base element, a cover plate, and a shiftable latch are visible;

FIG. 10 shows the base element according to FIG. 9 in isolation;

FIG. 11 shows the connecting element according to FIG. 9 in isolation;

FIG. 12 shows the cover plate according to FIG. 9 in isolation;

FIG. 13 shows the buckle element in a bottom view;

FIG. 14 shows the push element in isolation according to FIG. 9 in isolation;

FIG. 15 shows the shiftable latch according to FIG. 9 in isolation;

FIG. 16 shows a first lever of the locking device according to FIG. 9 in isolation;

FIG. 17 shows the first lever in engagement with a second lever of the locking device according to FIG. 9 in isolation;

FIG. 18 shows the second lever according to FIG. 17 in engagement with one slider;

FIG. 19 shows the engagement element according to the second embodiment in a rear view;

FIG. 20 shows the engagement element according to FIG. 19 in a front view;

FIG. 21 shows in a top view the cover element according to FIG. 9 in isolation;

FIG. 22 shows in a bottom view the cover element according to FIG. 21;

FIG. 23 shows in a cross sectional view the cover element according to FIG. 21;

FIG. 24 shows in a top view the suitcase with a third embodiment of the closure device assembly according to the present invention comprising an engagement element and a buckle element with, a cover element, a push element, and a double layer coil zipper arrangement;

FIG. 25 shows a cross-sectional view of the closure device assembly according to FIG. 24 attached to the suitcase;

FIG. 26 shows in a perspective view from the top the third embodiment of the closure device assembly according to FIG. 24 in isolation;

FIGS. 27, 28 & 30 shows in a perspective view from the bottom the third embodiment of the closure device assembly according to FIG. 24 in isolation;

FIG. 29 shows a cross-section through the closure device assembly according to FIGS. 26-28;

FIG. 31 shows a front view of the closure device assembly according to FIGS. 26-28;

FIG. 32 shows the base element of the closure device assembly according to FIG. 24;

FIG. 33 shows the cover plate of the closure device assembly according to FIG. 24;

FIG. 34 shows in a bottom view an embodiment of a counter plate for the closure device assembly according to FIG. 24;

FIG. 35 shows in a top view an embodiment of a counter plate for the closure device assembly according to FIG. 24;

FIG. 36 shows the push element with the lock bolt and the first lever in engagement with the second lever of the locking device with the biasing member;

FIG. 37 shows the first lever of the locking device in engagement with the zipper slider of the double layer coil zipper;

FIG. 38 shows in a perspective view a back side of a second embodiment of the engagement element;

FIG. 39 shows in a perspective view a front side the engagement element according to FIG. 38;

FIGS. 41 to 45 shows details of a preferred embodiment of the zipper slider with a two-part pull element.

### DESCRIPTION OF PREFERRED EMBODIMENTS

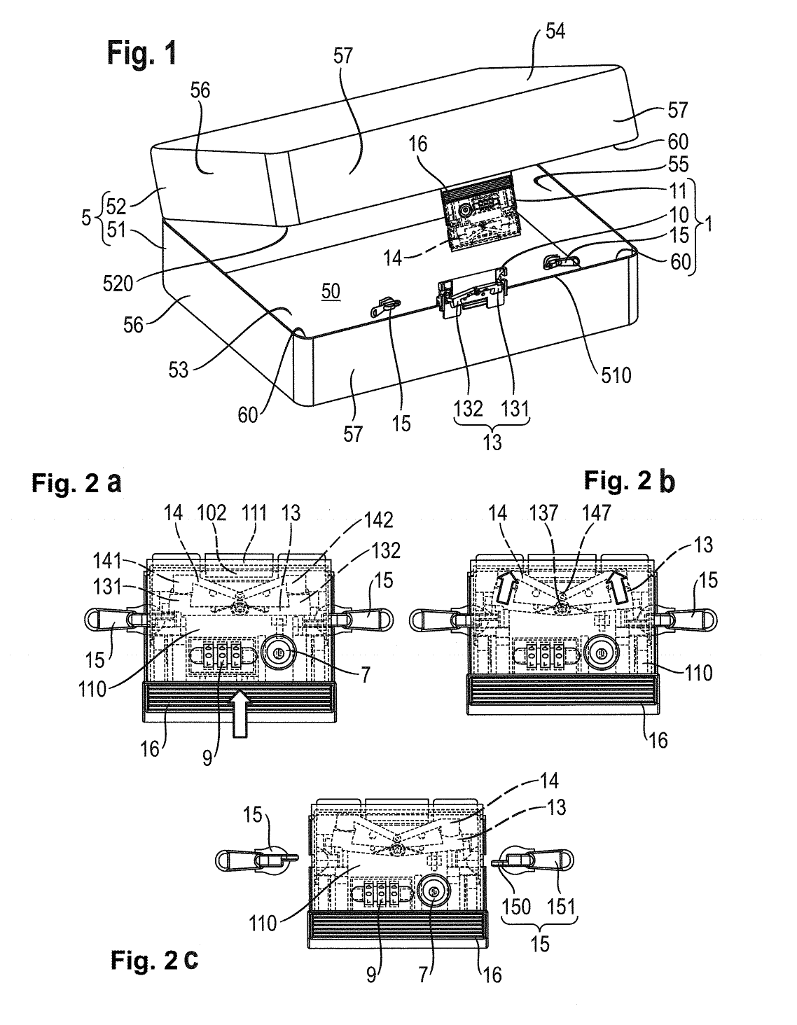

FIG. 1 shows a suitcase 5 with a first body portion 51 and a second body portion 52. The two body portions 51, 52 are substantially mirror-inverted half shells for forming a closed casing with an interior packing space 50. The first and second portions 51, 52 are pivotably connected to one another along a part of free edges 510, 520 of the portions 51, 52. FIG. 1 shows the suitcase 5 in a semi-open state such that the interior space 50 of the suitcase 5 is visible.

The suitcase 5 provides the casing with a front wall 53, a back wall 54, a top wall 55, a bottom wall 56, and first and second side walls 57, 58. The front wall 53 and the back wall 54 are forming major faces of the suitcase 5, wherein said first and second side walls 57, 58 are forming side faces of the suitcase 5 that extend between the front wall 53 and the back wall 54. The top wall 55 and the bottom wall 53 are forming top and bottom faces of the suitcase 5 that extend between the front wall 53 and the back wall 54.

Between the first and second body portions 51, 52 is arranged, along a remaining part of the free edges 510, 520, a zipper 60 for closing said suitcase 5 once the portions 51, 52 are in closed position, i.e. once the suitcase's interior space 50 is closed.

In a middle portion of the long narrow face of the first side wall 57 is arranged a closure device assembly 1 according to a first embodiment. The first embodiment shall now be explained with reference to FIGS. 1 to 7.

The closure device assembly 1 according to the first embodiment is designed as a toggle clamp with an engagement element 10 and a buckle element 11, the buckle element 11 having a knee-lever like design and therefore being pivotable in a three stage toggle motion.

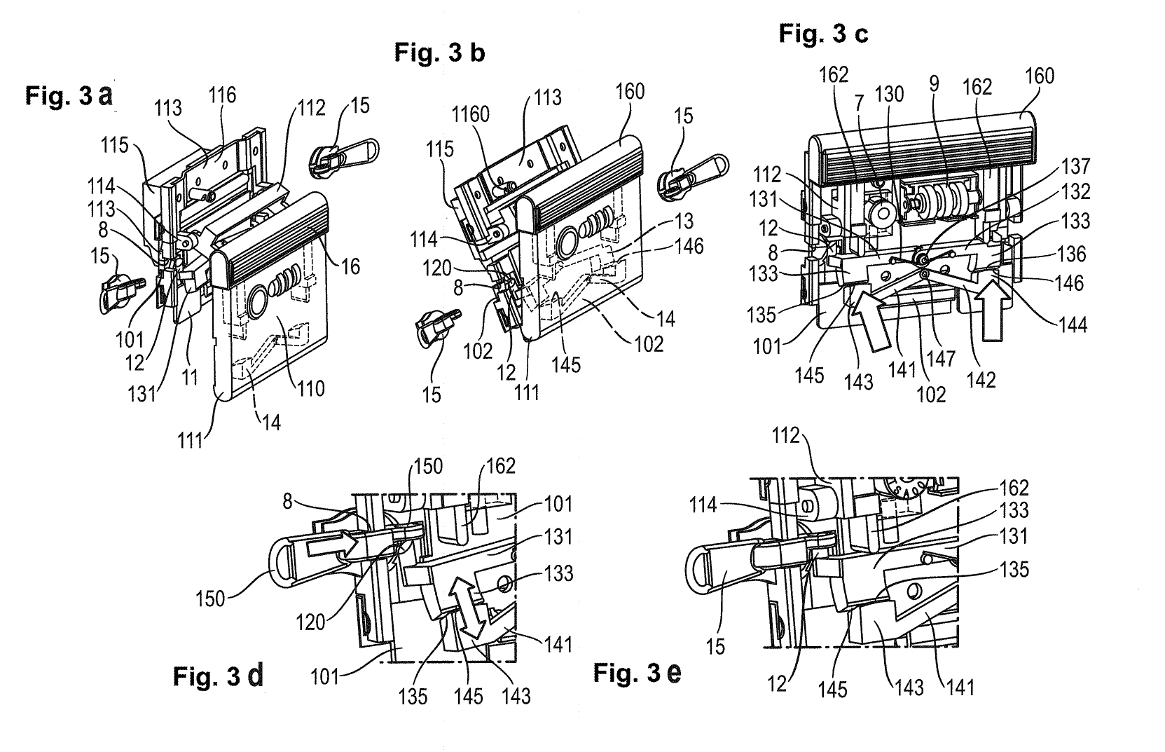

The engagement element 10 is attached, with a base element 101, to the first side wall part of the first body portion 51. The base element 101 protrudes over the zipper 60 toward the second body portion 52. Moreover, the engagement element 10 is arranged substantially parallel to the first side wall 57 and provides a hook-like engagement portion 102 (cf. FIG. 3c) being arranged on the base element 101 and facing outside for mutual engagement with the buckle element 11.

Close to the periphery edge of the first body portion 51, i.e. close to the zipper 60, is arranged, on the base element 101, a locking device 13 comprising a pair of pivotable first and second bolt lever arms 131, 132. Said lever arms 131, 132 are connected to one another at one of their first ends by means of a common pivot joint 137, the joint 137 being arranged in the middle region of the base element 101 that faces the outside (cf. FIG. 3c). The bolt lever arms 131, 132 extend from said pivot joint 137 substantially along the zipper 60 to their free second ends close to a periphery edge region of the base element 101. At their free second ends, the levers 131, 132 have enlarged, substantially cuboidal head portions 133, 134 such that both lever arms 131, 132 have a hammer-like design. The substantially cuboidal head portions 133, 134 have the same material thickness as the lever arms 131, 132 and protrude over said arms 131, 132 toward the front wall 53. FIGS. 1, 2a, and 3c show the bolt lever aims 131, 132 in locking position, i.e. they extend substantially parallel to the zipper 60. Faces of the head portions 133, 134 facing said front wall 53 in locking position of the levers 131, 132 are inclined contact surfaces 135, 136.

The bolt lever arms 131, 132 are pivotable, against the action of a biasing member 130, relative to the base element 101 in a plane substantially parallel to the first side wall 57, i.e. substantially parallel to a main face of the base element 101, and toward the front wall 53 of the first body portion 51. Said pivoting motion brings the bolt lever arms 131, 132 from said locking position (cf. FIG. 2a) into a release position (cf. FIG. 2b). The bolt biasing member 130 determines the default position of the locking device 13, which is the release position. The bolt biasing member 130 is a spring that is coiled around a pin at the pivot joint 137 and bears against pins on the actuation lever arms 131, 132.

The closure device assembly 1 further includes zipper sliders 15, which are designed for operation of and on said zipper 60. The sliders 15 comprise the engagement section 150 and the attachment section 152 are formed as a single-piece element (cf. FIG. 18). The attachment portion 152 is for attaching the puller tabs 151. The zipper sliders 15 have engagement sections 150 which are oriented to protrude in closing direction of the respective slider 15. The engagement sections 150 are pull rings formed rigidly onto the respective zipper slider 15, the rings lying in a plane parallel to the front wall 53 and in closing direction of the respective zipper slider 15. These engagement sections 150 may be inserted into gaps 8 between the engagement element 10 and the buckle element 11, under the cover element 110.

The engagement element 10 is arranged on the first body portion 51 such that the zipper sliders 15 extend, when in closed position, into said gaps 8 between the engagement element 10 and the buckle element 11 (cf. FIG. 3c).

The head portions 133,134 carry each a bolt 12 which protrude towards the second body portion 52, i.e. away from the front wall 53. The bolts 12 are arranged and designed to extend into the engagement sections 150 of the zipper sliders 15 once the bolt lever arms 131, 132 are in locking position and the zipper sliders 15 are in closed position, i.e. the puller rings 150 inserted into gap 8 (cf. FIG. 3e).

Once the zipper sliders 15 are caught by said bolts 12, the zipper sliders 15 are securely locked. Since the lever arms 131, 132 are pivotable (by actuation of the push element 16, see below) such that said bolts 12 disengage from the engagement sections 150, the zipper sliders 15 may be unlocked to freely move to open the zipper 60.

The engagement element 10 carries, on its base element 101, the hook-like second engagement portion 102 that protrudes outwardly and faces, with its open side, toward the first body portion 51. This second engagement portion 102 is adapted for mutual engagement with the buckle element 11.

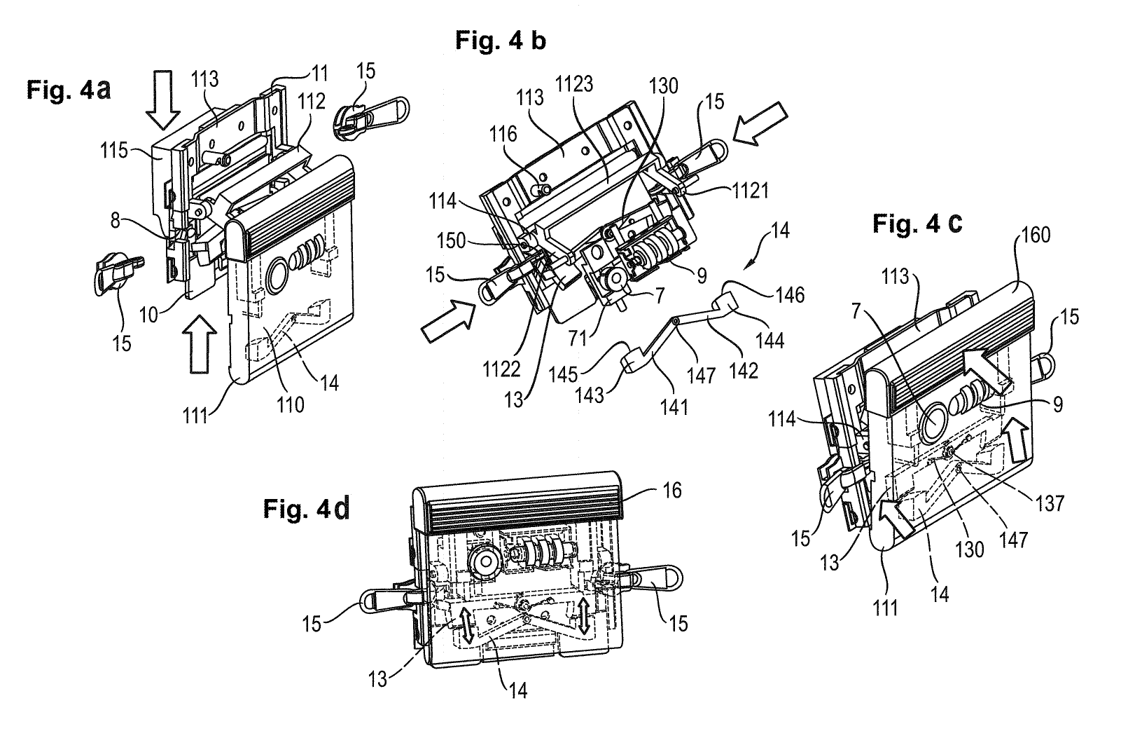

The buckle element 11 is designed to be moved in a toggle-movement between an open position (cf. FIG. 4a) and an engagement position (cf. FIG. 4d). In the engagement position, the buckle element 11 is hooked into the engagement element 10; in the open position, the buckle element 11 is disengaged from the engagement element 10.

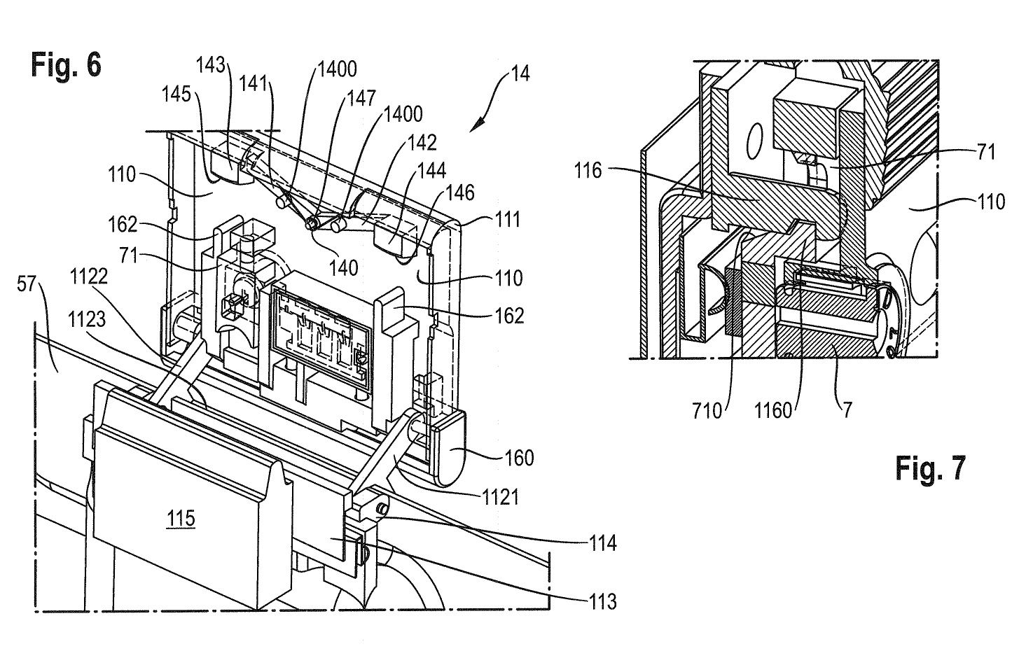

The buckle element 11 is designed to cover, when in the engagement position, the engagement element 10. Thereby, the engagement section 150 and the locking device 13 are well protected underneath the buckle element 11. For that reason, the buckle element 11 comprises the plate-like cover element 110 that is hinged to a plate-like base element 113 of the buckle element 11 by means of connecting lever 112 (cf. FIGS. 3a, 6).

The base plate 113 is connected to the second body portion 52 such that the buckle element 11 may be moved relative to the second body portion 52 and may be brought into the engagement position when the body portions 51, 52 are closed or almost closed, i.e. when there is still a gap of 5 millimeters to 50 millimeters between parts of the edges 510, 520 close to the closure device assembly 1. Moreover, the base element 113 has a guide element 115 (cf. FIG. 3a) for guiding the base element 101 of the engagement element 10 for proper engagement of the body portions 51, 52 during the closing of the suitcase 5.

The connecting lever 112 includes two lever arms 1121, 1122 (cf. FIG. 6) that are both hinged to the base plate 113 by means of hinges 114 fixedly attached to the base plate 113. The lever arms 1121, 1122 are pivotable in a plane parallel to the top and bottom walls 55, 56 and connected to one another by a connector element 1123 (cf. FIGS. 4b, 6). At opposing ends, the connecting lever arms 1121, 1122 are hinged to an edge region of the cover element 110. Opposite this edge region, the cover element 110 carries the first engagement portion 111. Accordingly, the cover element 110 is hinged by means of the double-hinge lever 112 to the base plate 113 such that a toggle clamp-like motion of the cover element 110, as depicted in FIGS. 4a-d, is possible.

The connecting lever 112 may be hinged to the base plate 113 and to the cover element 110 with including a spring in the hinge such that the default position of the cover element 110 and the lever 112 is the one as depicted in FIG. 4a.

The first engagement portion 111 is a curved end portion of the cover plate 110 (cf. FIG. 3a). The hook-like engagement portion 111 has its open side facing the lever 112. In FIGS. 4a and b, the engagement portions 102 and 111 are disengaged from one another. FIG. 4b shows the situation without the cover element 110 for clarity. Said first engagement portion 111 may be moved, by action of the toggle clamp mechanism, to be brought, in a first toggle motion, into mutual engagement with the second engagement portion 102 of the engagement element 10 (i.e. the buckle element is in engagement position). After said first toggle move, the two engagement portions 102, 111 are hooked into one another while the body portions 51, 52 may still are spaced from one another.

Preferably, the lever 112 and the cover element 110 are hinged to one another such that a maximum pivot angle between them is smaller than 160 degrees, preferably smaller than 120 degrees, i.e. preferably the lever 112 and the cover element 110 cannot be brought to lie within one plane. Accordingly, the cover element 110 is, during engagement with the second engagement portion 102, inclined with respect to the base element 113, until the buckle element is in engagement position (cf. FIG. 4d).

After the first toggle motion, the buckle element 11 may be shifted in the second toggle motion toward the second body portion 52, i.e. the first and second body portions 51, 52 may be moved closer together. Since the first engagement portion 111 of the cover element 110 is hooked into the second engagement portion 102 of engagement element 10, the hinge portion of the cover element 110 describes, during this second toggle motion, a circular movement about the hinge 114 and comes into an maximum inclined position, while the engagement portion 111 is moved substantially laterally toward the second body portion 52 (cf. FIG. 4c).

After the second toggle motion, the hinge portion of the cover element 110 can be pushed down in a third toggle motion along said circular motion toward the base plate 113, whilst a distance between the first and second body portions 51, 52 is constantly reduced. At the end of the third toggle motion, the cover element 110 is parallel to the base element 113 and covers the lever 112, the closing device 13, and the actuation device 14. Moreover, the cover element 110 covers the gaps 8 such that it is only accessible along the zipper 60. Thereby, if the zipper sliders 15 are inserted with their engagement sections 150 into gaps 8, said engagement sections 150 are covered from all sides (cf. FIG. 4d).

Accordingly, closing the closure device assembly 1 helps in bringing together the first and second body portions 51, 52 of the suitcase 5, while the cover element 110 covers the sensitive parts of the zipper locking mechanism. This toggle action of the closure device assembly 1 thus may also help to properly close the suitcase 5, e.g., in case of overpacking. The body portions 51, 52 may be safely secured to one another by means of the closure device assembly 1 while the two portions 51, 52 are still spaced from one another and the zipper 60 is still open. Upon completing the toggle motion, the zipper may be conveniently closed. The toggle motion and the closing of the zipper may conveniently done single handed.

Furthermore, between the hinge portion and the first engagement portion 111 is arranged and actuation device 14. FIG. 4 also shows how the actuation device 14 works. The actuation device is arranged on an inside face of the cover element 110. The actuation device 14 comprises two actuation lever arms 141, 142 (cf. FIG. 4b). Said actuation lever arms 141, 142 are connected to one another at first ends by means of a common pivot joint 147, the joint 147 being arranged in the middle region of the cover element 110, shifted toward the first engagement portion 111. The actuation lever arms 141, 142 extend from said pivot joint 147 to their free second end close to a periphery edge region of the cover element 110. FIG. 4 shows the actuation lever aims 141, 142 in actuation position, i.e. extending substantially along the zipper 60.

At their free second ends, the levers 141, 142 have enlarged head portions 143, 144 such that both lever arms 141, 142 have a hammer-like design like the bolt lever arms 131, 132. The substantially cuboidal head portions 143, 144 have the same material thickness as the actuation lever arms 141, 142 and protrude over said arms 141, 142 away from the first engagement portion 111. Accordingly, the head portions 143, 144 of the actuation lever arms 141, 142 and the head portions 135, 136 of the bolt lever arm 131, 132 protrude to one another. In actuation position, faces of the head portions 143, 144 facing away from said first engagement portion 111 are inclined contact surfaces 145, 146 that are slanted to correspond with the respective inclined surfaces 135, 136 of the bolt lever arms 131, 132.

Moreover, the lever arms 141, 142 are adapted to be pivoted in a plane substantially parallel to the cover element 110 and relative to the cover element 110 out of the actuation position (cf. FIG. 2a) into an initial position (cf. FIG. 2b), this pivot motion being against action of a biasing member 140. Accordingly, the default position of the actuation device 14 is the actuation position. The biasing member is a spring that is coiled around a pin at the pivot joint 147 and bears against pins 1400 on the actuation lever arms 141, 142.

The locking device 13 and the actuation device 14 are arranged such that upon engagement of the first and second engagement portions 111, 101, and after the first and second toggle motions, i.e. after the cover element 110 has been brought into the inclined position (cf. FIG. 4c), the actuation device 14 brings the locking device 13, during the third toggle motion, from its default release position into the locking position, while the buckle element 11 is pushed down in the third toggle motion. At the end of the second toggle motion, the contact surfaces 135, 145 and 136, 146 are in contact. During the third toggle motion, the first engagement portion 111 is moved toward the second body portion 52, while the actuation lever arms 141, 142 push the bolt lever arms 131, 132 from release position (cf. FIG. 4c) into locking position (cf. FIG. 4d). This is possible since the actuation biasing member 140 overrides the bolt biasing member 130 and forces the bolts 12 in to locking position to catch the engagement section 150 of the sipper slider 15 protruding into said gap 8.

The inclined surfaces 135, 136, 145, 146 are provided such that the come into parallel contact with one another at the end of the second toggle motion such that, during the third toggle motion, the actuation biasing member 140 may override the bolt biasing member 130 such as to move the bolts 12 from the release position into the locking position.

Biasing members 130, 140 (or others) may be mechanical springs, e.g. helical springs or leaf springs. Other means for providing the biasing force may be used.

After completion of the third toggle motion the closure device assembly 1 is closed (cf. FIGS. 2a, 3e, 4d). The cover element 110 covers the locking and the actuation device 13, 14, and the engagement sections 150 of the zipper sliders 15 in closed position.

In order to release the locked zipper sliders 150, a push element 16 with a push button 160 is provided. The push button 160 is arranged along a periphery edge of the cover element 110, on the side facing the back wall 54, i.e. opposite of the first engagement portion 111 (cf. FIGS. 2, 6).

The push button 160 extends along the hinge portion, i.e. along the lever 112 side edge of the cover element 110, and may be grasped and pushed out of its default position, preferably against the action of a biasing member, toward the first engagement portion 111. The push button 160 moves relative to the cover element 110.

The push element 16 comprises two rod-like contact elements 162 extending rectangular to the push button 160 and parallel to the cover element 110 toward the actuation device 14.

The principle of the push element 16 is now explained with reference to FIGS. 2a-d, which show the closure device assembly 1 in closed position. FIG. 2a shows the closure device assembly 1 with the push element 16 in default position, FIG. 2b shows the push element 16 in actuation position. In the default position, the contact elements 162 extend between the cover element 110 and the base plate 113 to contact the bolt lever arms 131, 132, close to arm-side end portions of the head portions. Upon pushing the push button 160, the contact elements 162 are pushed toward the bolt lever arms 131, 132 and pivot them out of the locking position into the release position. Accordingly, the user pushing the button pivots the bolt lever arms 131, 132 against the actions of the actuation biasing member 140. Once the push button 160 is depressed, the bolts 12 give the zipper sliders 15 free as the pivot into the release position and the user may open the zipper 60.

The push element 16 further includes a guide pin 163 which is arranged between the two contact elements 162 and extends parallel thereto. Moreover, between the two contact elements 162 is arranged a lock 9, preferably a number combination lock.

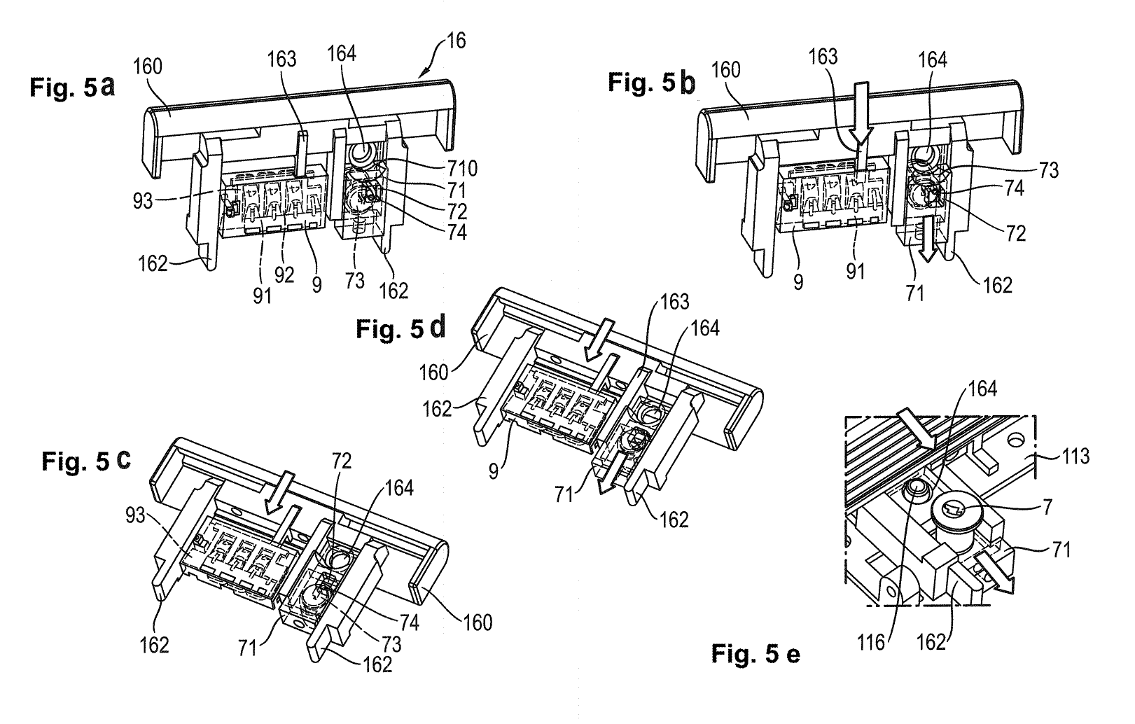

The lock 9 comprises a plurality of number wheels 92 and a recess 91 arranged such that the guide pin 163 has to extend into the recess 91 if the push button 160 is moved from the default position (cf. FIG. 5a) to depressed position (cf. FIG. 5b). The lock 9 allows such an extension of the guide pin 163 into recess 91 only upon setting the correct number with the number wheels (cf. FIG. 5b). If the wrong combination is set, a blocking element 93 blocks the guide pin 116, whereby the push button 160 is blocked and the closure device assembly 1 may not be opened.

The lock 9 further comprises a locking pin 116 extending normally from the base element 113. The locking pin 116 has, close to its free end, a radial facing recess 1160 (cf. FIG. 7). On the inside facing side of the cover element 110, i.e. where the actuation device 14 is arranged (cf. FIG. 6), is further arranged a catch mechanism 71, 164 for catching and locking said locking pin 116. The catch mechanism comprises a biased sledge 71 with a recess 164. The sledge 71 is arranged between the contact elements 162 and shiftable along said contact elements 162 from a biased locked position against a sledge biasing member to a free position. Accordingly, the default position of the sledge 71 is the locked position. The recess 164 is an oblong hole extending normally to the cover element 110 through the sledge 71.

During the third toggle motion, the inclined cover element 110 is pressed down such that the locking pin 116 runs into said recess 164 in the sledge 71. The sledge 71 has a ramp 710 (cf. FIG. 5a). Upon penetration of the pin 116 into recess 164 a tip of the pin 116 runs along said ramp 710, moves the sledge 71 against the sledge biasing member from the locked to the free position, wherein, upon full penetration, the sledge 71 snaps back into locked position, as the pin 116 loses contact with the ramp 710 due to the recess 1160. The ramp 710 then extends into recess 1160 (cf. FIG. 7), whereby the buckle element 11 is locked at the end of the third toggle motion.

Upon depressing the push button 160, after having set the correct number combination with wheels 92, the sledge 71 is moved against its biasing member by the push button 160 from the locked position to the free position such that the buckle element 10 may be disengaged from the engagement element 10.

In the sledge 71 is also provided a TSA lock 7 (cf. FIG. 5). The TSA lock comprises a key activatable cylinder 73 with an eccentrically arranged distal pin 74. Said distal pin 74 extends into a pin recess 72 in sledge 71. The distal pin 74 moves on a part circular line upon locking and unlocking the TSA lock 7. The pin recess 72 is designed to allow, in locked state of the TSA lock 7 (cf. FIGS. 5a-c), the sledge 71 motion with the push button 160 from default button position (cf. FIG. 5a) to depressed button position (cf. FIG. 5b). If the lock 9 is in locked position as the wheels 92 are not set correctly (cf. FIG. 5c), the locked TSA cylinder 73 may be rotated, whereupon the distal pin 74 contacts the sledge 71 in recess 72 and moves on its part circular path the sledge 71 from locked position (cf. FIG. 5d) to unlocked position (cf. FIG. 5e) such that the sledge 71 disengages from locking pin 116 and the buckle element may be moved. Accordingly, the lock 9 may be overridden by means of the TSA lock 7.

A further feature of the closure device assembly 1 is now described with reference to FIGS. 3a-d. This further feature allows the zipper sliders 15 to be moved into said gaps 8 with the locking device 13 being in locking position.

In order to achieve this function, said bolts 12 of the locking device 13 have slanted surfaces 120 at their tips (cf. FIG. 3d). The user may close the zipper 60 by moving the zipper sliders 15 along the zipper 60 and press the engagement sections 150 into said gaps 8 between the buckle element 11 and engagement element 10. The bolts 12 as slanted such that the engagement sections 150, upon contacting the bolts 12, slide along the slanted bolt tips 120 such that the bolts 12 and consequently also the levers 131, 132 are pivoted back about their pivot center 137 out of the closed into the open position. Accordingly, the user may pivot the bolt lever arms 131, 132 with said zipper slider 15 against the action of the actuation biasing member 140 of the actuation device 14 from locking position to release position. After the zipper sliders 15 have been moved to closed position, i.e. the engagement portions 150 fully engage into the gaps 8 under coverage of the cover element 110, the lever arms 131, 131 snap back under action of the actuation biasing member 140. Thereby, the zipper sliders 15 are locked in the engagement element 10. Accordingly, the closure device assembly 1 may be closed without using any key and without the need to set the correct number combination.

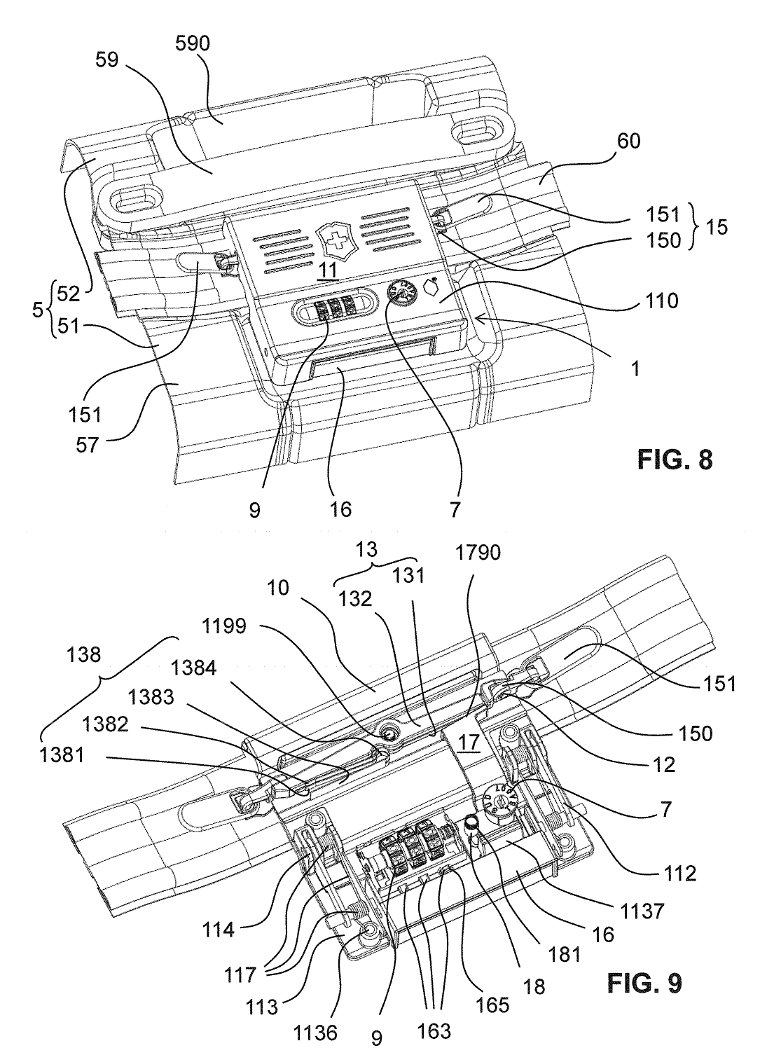

In the following, a second embodiment of the closure device assembly 1 according to the present invention shall be explained with reference to FIGS. 8 to 23. Features of the second embodiment are designated with the same reference numerals where the functionalities of the respective features substantially correspond to one another.

The closure device assembly 1 according to the second embodiment is also designed as a toggle clamp with engagement element 10 and buckle element 11, the buckle element 11 having a knee-lever like design and therefore being pivotable in a three stage toggle motion between the open position, the engagement position, and the closed position.

FIG. 8 shows the closure device assembly 1 arranged on the suitcase 5 next to a handle 59, the handle 59 being arranged in a handle recess 590 located on the second body portion 52. The closure device assembly 1 is depicted in closed position.

The closure device assembly 1 comprises the engagement element 10 (cf. FIGS. 9 and 19, 20), the engagement element 10 being fixedly attached to the second body portion 52.

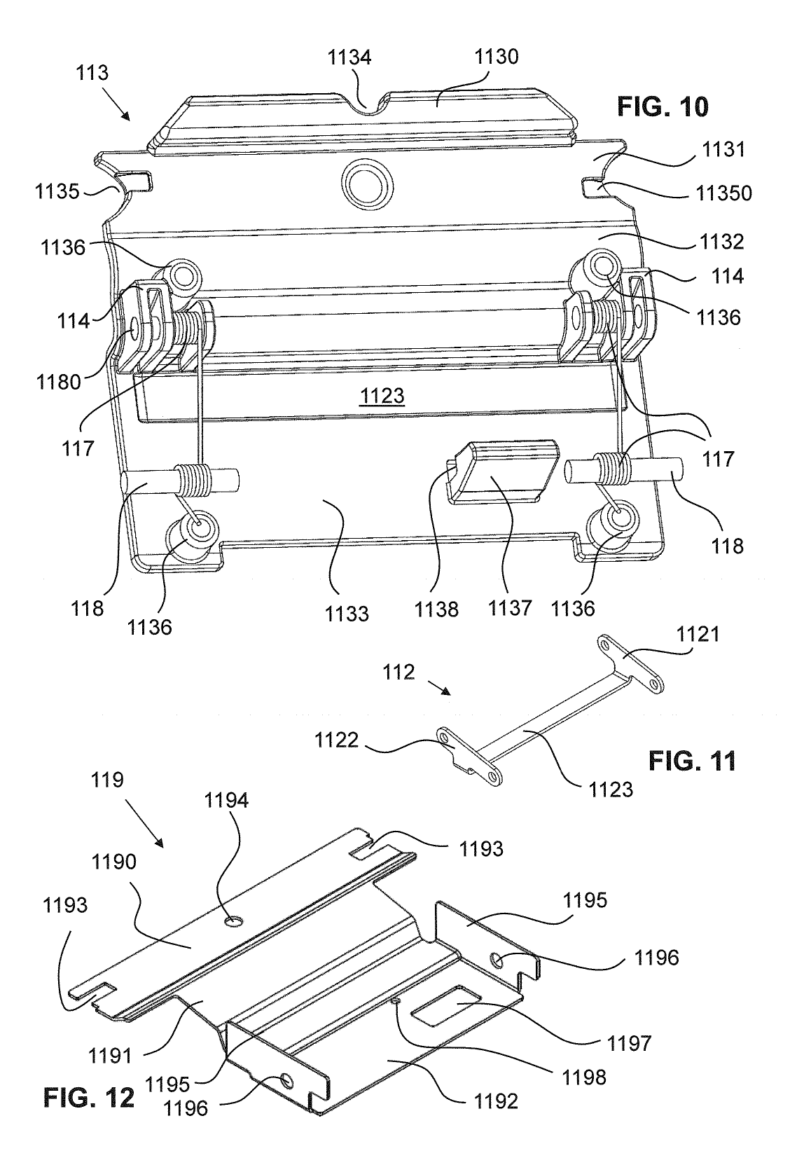

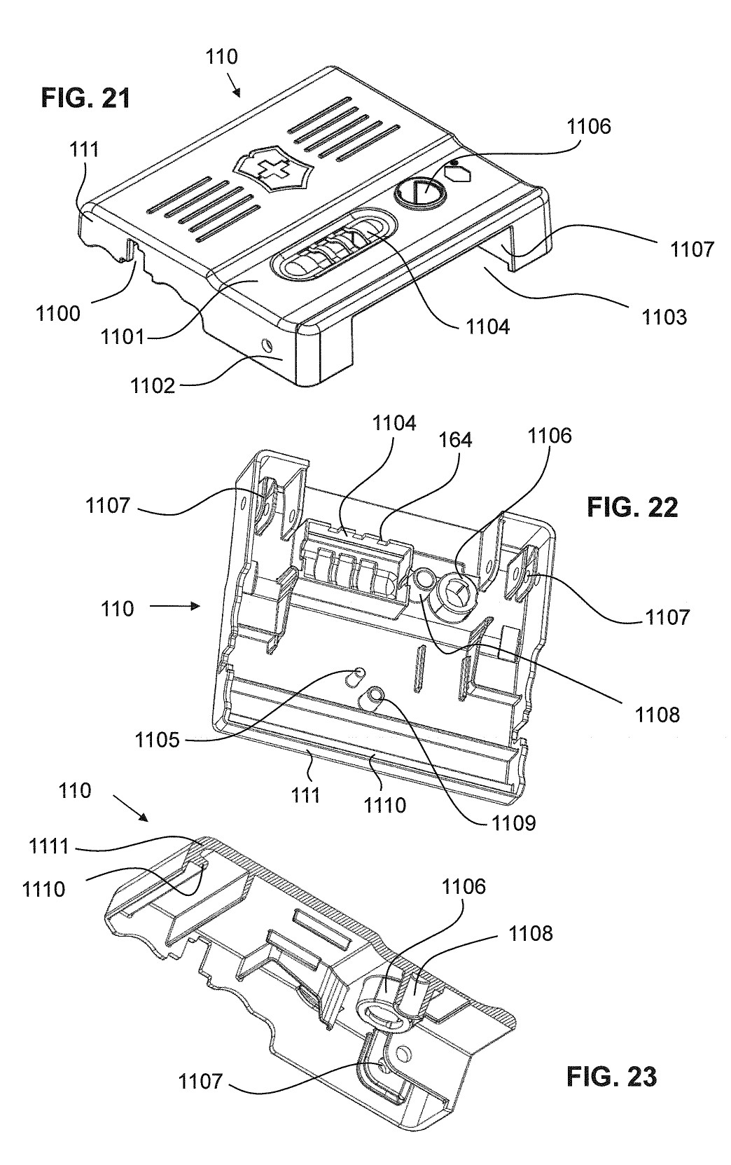

The closure device assembly 1 further comprises the buckle element 11 fixedly attached to the first body portion 51 via a base element 113 (cf. FIG. 10), the base element 113 being fastened to the first body portion 51. The buckle element 11 comprises the cover element 110 (cf. FIGS. 21 to 23) and said base element 113 that are connected to one another through the lever-type connecting element 112 (cf. FIGS. 10 and 11) in a hinged manner. The connecting element 112 is hinged to both elements 110, 113 via axles 118, 1180 (cf. FIG. 10) such that the cover element 110 is moveable relative to the fixed base element 113 in a pivotable manner.

As can be seen in FIG. 8, the buckle element 11 extends over the zipper 60 and is adapted to engage into and to hold fastened the engagement element 10 thereby locking the first and second body portions 51, 52 of the suitcase 5 to one another. When the closure device assembly 1 is closed, the buckle element 11 is in engagement with the engagement element 10 and covers the entire engagement element 10 and parts of the zipper sliders 15, i.e. their engagement sections 150. Thereby, the cover element 110 shields the locking mechanics of the closure device assembly 1 from manipulation.

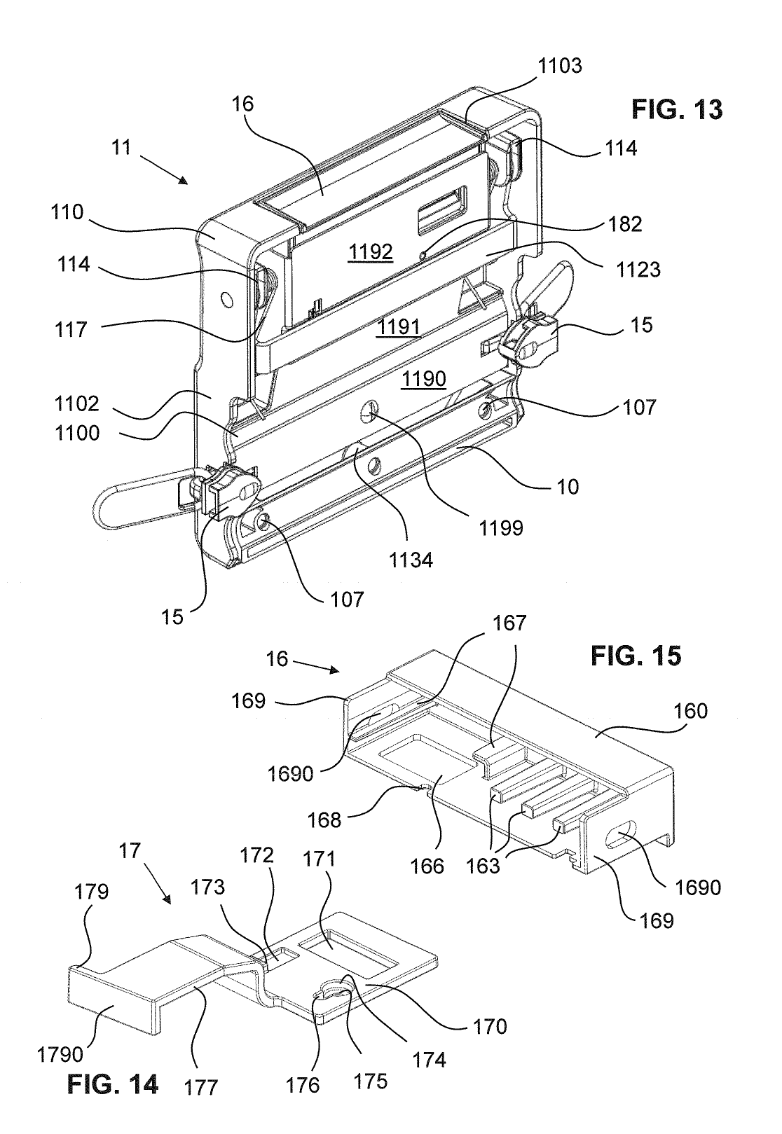

The engagement element 10 is fixedly attached to the first side wall part of the second body portion 52 by bolt connections extending through the suitcase wall and into the holes 107 (cf. FIG. 13). Other connections are conceivable.

Details of the engagement element 10 are shown in FIGS. 19 and 20. It is designed as a single-piece longitudinal rod extending with its longitudinal axis parallel to the zipper 60 and parallel to the first side wall 57. The engagement element 10 provides a hook-like second engagement portion 102 formed by a front groove 103 and an overlap 103. The groove 103 is facing away from the zipper 60 (in FIG. 8 toward the handle 59) and configured for mutual engagement with the buckle element 11 (more precisely with the cover element's engagement web 1110, cf. FIG. 23). The groove 103 has a height of, e.g., 2 to 4 millimeters and slightly tapers towards its depth for guiding and properly receiving web 1110.

On the back side of the engagement element 10 is provided a back slot 105 that extends over more than half of the diameter of element 10 into the latter and in longitudinal direction. The slot 105 is arranged to receive the engagement section 1130 of the base element 113 (cf. FIG. 10). The engagement section 1130 avoids that the engagement element 10 is pulled out of the engagement with the first engagement portion 111 of the buckle element 11. In other words, the engagement element 10 is trapped between the engagement section 1130 of the base element 113 and the first engagement portion 111 of the buckle element 11. The back slot 105 extends between side walls 106 that act as side stops for the engagement section 1130. The back slot 105 has, in its lengthwise middle region, a cylinder 108 that is arranged in the depth of the slot 105 and extends normally to the suitcase wall to which the element 10 is attached and out of the depth of slot 105. The diameter of the cylinder 108 may be 5 to 15 millimeters. The cylinder 108 guides and further fixes the engagement section 1130 of the base element 113 in a correct seat and therefore allows for a safe engagement of the engagement element 10 and the buckle element 11.

The buckle element 11 comprises a robust, single-piece cover element 110, for example, from a metal or plastics. Details of the cover element 110 are shown in FIGS. 20 to 23. The cover element 1101 is a single piece element that comprises a cover plate 1101 with side walls 1102 extending normally and down in the same direction. The side walls 1102 are arranged circumferentially around peripheral edges of the cover plate 1101. The side walls 1102 have recesses 1100 for the zipper 60 and for the zipper sliders 15, and recess 1103 for the push element 16. Moreover, in the lateral side walls 1102 are arranged through holes for receiving first axles 118 (cf. FIG. 10). In the front most side wall 1102 is arranged an engagement web 1110 (cf. FIG. 23) for engagement into front groove 103 of engagement element 10 (cf. FIG. 19).

The cover element 110 may be made from a metal sheet material or from a synthetic material. It comprises a reception structure 1104 for housing the suitcase lock 9 that extends through the cover plate 1101 for manual operation from outside. The housing 1104 comprises recesses 164 for the guide pins 163 of the push element 16 (cf. FIG. 15 with FIGS. 22 and 9). The guide pins 163 cooperate with lock 9, the latter being of conventional design.

FIG. 9 shows the closure device 1 without the cover element 110. If the lock 9 is open (correct on-combination of the three number wheels in, e.g., FIG. 9), the push button 160 may be pushed into the cover element 110, whereby the guide pins 163 further engage into recesses 164. The biasing member 165, a helical spring, biases the push element 160 such that it returns to its initial position after the push force is released. Additionally, the biasing member 138 may help to reset the push element 16, see below. If the lock 9 is locked, it blocks the pins 163 from moving into recesses 164 by means of a further plate; the push button 160 may not be pushed.

The cover element 110 has a substantially flat to surface and a structured bottom surface that comprises a hollow cylinder structure 1106 for receiving the TSA lock 7 (cf. FIGS. 21, 22). Moreover, the cover element 110 has, between the housing structure 1104 for the lock 9 and the cylinder 1106 for the TSA lock 7, a further hollow cylinder 1108 (cf. FIG. 22) for receiving and guiding a spring biased lock bolt 18 (cf. FIG. 9). The spring member 181 is arranged in the depth of the hollow cylinder 1108 and the bolt 18 is placed on said spring 181 in the cylinder 1108 as well such that the spring 181 pushed the bolt 18 toward a bottom plate 119. Furthermore, a pin 1105 is arranged for securing the biasing member 138 and a further hollow cylinder 1109 for forming an axle for the locking device 13.

The bottom plate 119 is shown in FIG. 12 and partially closes the cover element 110 on the bottom side such that an interior space is created between the cover element 110 and the bottom plate 119 (cf. FIG. 13).

The bottom plate 119 has a first section 1190, a second section 1191, and a third section 1192 (cf. FIG. 12). It may be made from, e.g., a metal sheet material. The first section 1190 is placed over the zipper 60 when the assembly 1 is closed (cf. FIG. 9).

The first section 1190 has a central through hole 1194 through which a screw 1199 (cf. FIG. 13) is guided that engages into the reception 1109 (cf. FIG. 22). The screw 1199 and the cylinder 1109 with screw hole provide the axle for the locking device 13 (cf. FIG. 9 and text below). The first section 1190 has lateral recesses 1193 such that the sliders 15 may engage with their engagement section 150 into the buckle element 11 in order to be caught and locked therein.

The second section 1191 is a narrowed transition section that connects the first and second sections 1190, 1192 to one another.

The third section 1192 has, in its back right quadrant, a rectangular recess 1197 (cf. FIG. 12). This recess 1197 allows a hook element 1137 (cf. FIGS. 9 and 10) to engage into the interior space between cover element 110 and bottom plate 119. In front of the recess 1197 is a through hole for a pin 182 (cf. FIG. 13) that extends from the lock bolt 18. The third section has side walls 1195 that extend towards the cover plate 1101 and are arranged between the cover element's side walls 1102.

First axles 118 extend into through holes 1196 in side walls 1195 of the bottom plate 119 and through holes in the side walls 1102 of the cover element 110, thereby fixing, together with screw 1199 and reception 1109, cover element 110 and bottom plate 119 to one another. The first axles 118 also connect the cover element 110 and bottom plate 119 to the connecting member 112 in a pivotable manner. Second axles 1180 (cf. FIG. 10) connect the connecting member 112 to hinge portions 114 on the base element 113 in a pivotable manner. In order to keep the cover element 110 substantially parallel to the top wall of the suitcase 5, a biasing members 117 is arranged on the first and second axles 118, 1180 as shown in FIGS. 9, 10, 13. Accordingly, the cover element 110 and the bottom plate 119 may be pivotable whilst being substantially parallel to the base element 113 through action of the biasing members 117. The first engagement portion 111 of the cover element 110 may be moved to extend to the front and to engage into the engagement element 10, wherein the cover element 110 may then be pulled back to finally close the suitcase 5 and pushed down to close the closure device assembly 1. The sliders 15 may then be inserted into the respective slots to engage with the securing element 13.

In said interior space are further arranged, besides the locks 7 and 9, a shiftable latch element 17 and said locking device 13 as shown in FIG. 9.

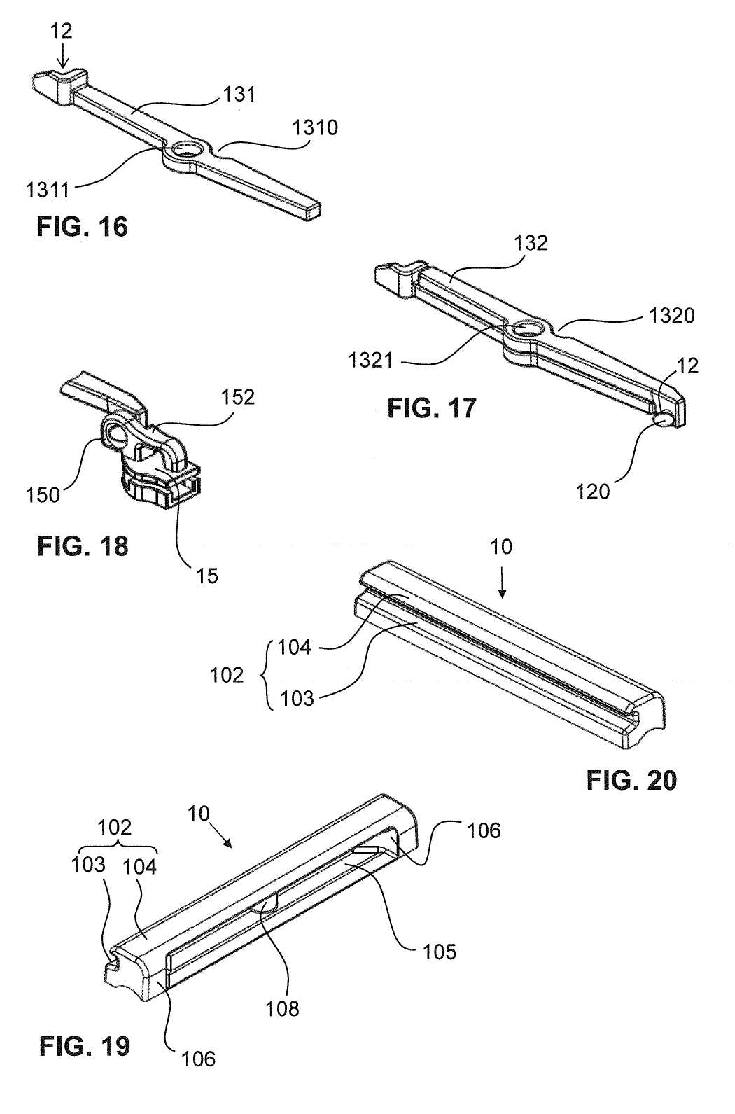

The locking device 13 is shown in FIGS. 9 and 16 to 18. The locking device 13 comprises two two-armed levers 131, 132, each with a central recess 1311, 1321. The first lever 131 is shown in FIG. 16. It has a first arm with a bolt 12 (indicated by an arrow). Said bolt 12 extends towards the push element 16 and has a slanted surface 120. On top of the first lever 131 is arranged the second lever 132 as shown in FIG. 17. The second lever 132 also has a bolt 12 with a slanted surface 120. This bolt 12 on the second lever 132 extends, however, in the other direction away from the push element 16.

FIG. 18 shows this bolt 12 in engagement with engagement section 150 of slider 15. FIG. 18 also shows the slider 15 with the formed-upon engagement ring 150. Engagement section 150 and slider 15 are thus provided as one single piece element.

The two levers 131, 132 receive the screw 1199 and cylinder 1109 through their central recesses 1311, 1321 as shown in FIG. 9 and are therefore rotatable, both bolts 12 extending in clockwise direction when observed from above. The levers 131, 132 have on their back side a recess 1310, 1320 facing the push element 16 and being adapted for accommodating a loop 1384 of a bolt biasing member 138 (cf. FIG. 9).

The biasing member 138 is substantially U-shaped having two legs connected by loop 1384. One leg has two separate contact tongues 1381, 1382. The first contact tongue 1381 contacts the recessed arm of the first lever 131; the second tongue 1382 contacts the recessed arm of the second lever 132. The loop 1384 is received in pin 1105 of the cover element 110 (cf. FIG. 22). Pin 1105 fixes and stabilizes the biasing member 138 in the buckle element 11. The second leg of the biasing member 138, the mounting tongue 1383 (cf. FIG. 9), is fixed. Accordingly, the first and second lever 131, 132 each with its bolt 12 are biased separately from one another by first and second contact tongues 1381, 1382, respectively, such that the biasing force increases upon rotation of the levers 131, 132 in counter clockwise direction (as seen in FIG. 9).

FIG. 9 shows the locking device 13 in locked position (latch 17 in initial position). In order to release the sliders 15, the levers 131, 132 have to be rotated in anti clockwise direction against the biasing member 138. This is achieved by the shiftable latch element 17 which can be shifted from the initial position into the actuation position such as to rotate the levers 131, 132 into the release position.

The latch element 17 corresponds functionally to the actuation device 14 of the first embodiment and is shown in isolation in FIG. 14. FIG. 9 shows the latch element 17 installed in the buckle element 11 and in initial position. The single-piece latch element 17 is a bent metal sheet element with a base plate 170, and a contact portion 179 for contacting the levers 131,132. The base plate 170 and the contact portion 179 are connected to one another through the connecting portion 177. The base plate 170 is arranged partly in the push button 160 above the third section 1192 of the bottom plate 119; the connecting portion 177 extends over the second section 1191 of the bottom plate 119. The contact portion 179 is arranged above the first section 1190 of the bottom plate 119.

The push button 160 is inserted into the internal space between the cover element 110 and the bottom plate 119 and has a guiding structure 167 from webs for guiding the latch element 17 perpendicularly to the zipper 60 (cf. FIG. 15) between the initial and the actuation positions, i.e. in the direction of the pins 163, i.e. in push direction of the push element 16. Between the guiding webs of structure 167, the push element 16 has a recess 166 that is arranged to receive the hook element 1137 when closing the closure device assembly 1 (cf. FIG. 9).

The latch base plate 170 has a further recess 171 (cf. FIG. 14). The recesses 171, 1197, 166 of the latch element 1, the bottom plate 119, and the push element 16, respectively, are arranged and configured, on the one hand, such that the hook element 1137 can always extend into and be removed from the bottom plate recess 1197 and push element recess 166. On the other hand, the design is such that the hook element 1137 can always be pushed into the latch recess 171 (irrespective of the latch element 17 being in the initial or in the actuation position) but can only be retracted therefrom when the latch 17 is in actuation position. When the hook element 1137 extends into the recess 171 and the latch 17 is in initial position, the hook element 1137 bears with its stop surface 1138 (cf. FIG. 10) against the peripheral edge region defining the recess 171 (cf. FIG. 9) The contact portion 179 has a foot portion providing an inclined contact surface 1790 for contacting the levers 131, 132 (cf. FIG. 9). The inclination is such that said contact surface 1790 is, when in contact with the levers 131, 132, parallel to respective contact surfaces of the levers 131, 132 in release position.

The push element 16 has in its side walls 169 longitudinal holes 1690 (cf. FIG. 13). The first axles 118 also extend into these longitudinal holes 1690, whereby the push element 16 is properly guided in the buckle element 11. The longitudinal holes 1690 define the actuation position of the push button 160 and therefore also the actuation position of the latch element 17 and also the initial position of push button 160 and latch element 17.

Moreover, the buckle element 11 is equipped with an automatic mechanism controlling the movement of the latch element 17. This automatic mechanism allows the latch mechanism (latch plus automatic mechanism) to function like the actuation device 14 as described above, i.e. that said actuation device 14 is adapted for moving said bolt 12 against said bolt biasing member from said release position into said locking position upon closing the closure device assembly 1.

Said automatic mechanism functions as follows. The base plate 170 of the latch element 17 has a further blind hole 174 open toward the lock bolt 18. In the center of the blind hole 174 is a smaller through hole 175 for the pin 182 extending downward from the lock bolt 18. The through hole 175 and the previously mentioned through hole 1198 in the bottom plate 119 (cf. FIG. 12) are sized to fit the pin 182 and to be in alignment once the latch element 17 is in actuation position. The blind hole 174 is dimensioned such that, once the two through holes 175 and 1198 are aligned to receive the pin 182, the lock bolt 18 may engage into the depth of the blind hole 174 through the action of its spring 181. Then, the pin 182 extends into the two aligned through holes 175, 1198 and protrudes beyond the bottom surface of the bottom plate 119 (cf. FIG. 13). Consequently, the lock bolt 18 fixes the slidingly arranged latch 17 relative to the cover element 110 in the actuation position; the sliders 15 are then released. Upon closing the closure device assembly 1 (or upon pushing manually onto pin 182) pin 182 is pressed back against spring 181 to be flush with the bottom surface of bottom plate 119, the spring 181 is compressed. Thereby, the bolt 18 moves out of the blind hole 174 and the biasing member 138 may push the latch 17 via the levers 131, 132 back into the initial position such as to lock the sliders 15 (if any are present in the buckle element 15). Once the latch 17 moves into initial position, the pin 182 is received in slots 176 (cf. FIG. 14) and 168 (cf. FIG. 15).

Accordingly, the automatic mechanism ensures that the locking device 13 is in locking position if the closure device assembly is closed. If then the push button 160 is pushed, the latch 17 moves and the sliders 15 are released. If the cover element 110 is not moved, the latch 17 travels under action of biasing member 138 back into initial position upon release of the push button 160 as the bolt pin 182 cannot protrude over the bottom surface of bottom plate 113 such that the lock bolt 18 is prevented from engaging into blind hole 174. If the cover element 110 is, however, moved the lock bolt 18 engages into blind hole 174 and the sliders 15 are released until pin 182 is pushed back to be flush with the bottom plate 113.

The push button 160 has the slot 168 such that the push button 160 may not be pushed from initial position to actuation position if the lock bolt 18 engages into blind hole 174 and pin 182 protrudes through the through hole 175.

Moreover, the TSA locking cylinder 7 is arranged in the hollow cylinder 1106. At the bottom side, the TSA cylinder 7 has a downward facing TSA pin (extending parallel to pin 182). This TSA pin engages into a groove 172 arranged on the top surface of latch element 17 (cf. FIG. 14). At the front end of the groove 172 is arranged a stop web 173. If the TSA lock 7 is in locked position the TSA pin engages into the groove 172. The groove 172 has a length such that the latch 17 can freely slide between the initial and the activation position. In the initial position, the TSA pin is in contact with the stop web 173. If a TSA officer wants to unlock the suitcase 5, he may rotate the TSA cylinder 7, whereby the TSA pin pushes against the stop web 173 and consequently pushed the latch 17 to slide from initial position into activation position such that the biasing member 138 is compressed and the levers 131, 132 release the sliders 15 and the hook element 1137 is disengaged such that the cover element 110 may be moved. The officer can open the closure device assembly 1.

The base element 113 of the buckle element 11 is fixedly connected to the first body portion 51 by means of bolt connections including the receiving sections 1136 (cf. FIG. 10). Other connection means are conceivable. The bolts extend through the suitcase wall into the receiving sections 1136 and fixedly connect the base element 113 to the suitcase 5.

The connecting element 112 is hinged via second axles 1180 to the hinge portions 114 arranged on the base element 113. The hinges/axles are biased by means of biasing member 117 (see below).

The base element 113 is a single-piece element from sheet metal or plastics and has a tapering engagement section 1130, a first section 1131, a second section 1132, and a third section 1133.

The engagement section 1130 is designed to extend into back slot 105 of the engagement element (cf. FIG. 19) when the closure device assembly 1 is closed. The engagement section 1130 moves to engagement with the closing motion of the body portions 51, 52. The tapering section 1130 is tapered at its longitudinal edges for easy and secure engagement into slot 105. Moreover, the engagement section 1130 has a recess 1134 for receiving cylinder 108 arranged in the slot 105. This further secures the engagement section 1130 in the engagement element 10.

Accordingly, the buckle element 11 engages into the engagement element 10 from both sides, i.e. with the engagement web 1110 and with the engagement section 1130.

The first section 1131 has recesses 1135 for the sliders 15. The recesses 1135 have grooves 11350 for receiving and guiding the lower part of the engagement sections 150 of the sliders 15 during their engagement with the bolts 12. Moreover, the first section 1131 has a bulge for receiving the head of the screw 1199.

The second section 1132 carries two of the receiving sections 1136 and in part the hinges 114 and is shaped to extend over part of the zipper 60.

The third section 1133 carries the remaining part of the hinges 114 and two further receiving sections 1136 for connection with the suitcase 5. Moreover, the third section provides the hook element 1137 which secures the latch 17 (and thereby the cover element 110), if the latch is in initial position.

The single-piece connecting element 112 is hinged via hinges 114, 1180 to the base element 113 and via hinges 1107, 118 to the cover element 110. The connecting element 112 comprises the first lever atm 1121 and the second lever arm of 1122. The first and second lever arms 1121, 1122 have at their ends through holes for receiving the first and second axles 118, 1180, respectively. Moreover, the first and second lever arms 1121, 1122 are connected to one another via the connector element 1123. This increases stability and allows for a synchronous movement of both lever arms 1121, 1122 such that the cover element 110 may remain substantially parallel to the base element 113 during pivoting about axles 118, 1180 whilst allowing inclined position when engaging with the engagement element 10.

Accordingly, the base element 113, the connecting lever element 112 and the cover element 110 with its bottom plate 119 form a knee-lever for toggle motion or, in other words, a toggle-clamp like mechanical structure. The cover element 110 may be pivoted relative to the base element 113 between the open and engagement positions. In the engagement position the cover element 110 extends over the zipper 60 engages with the engagement element 10 on the second body portion 52. This is a first securing stage in which the suitcase 5 may still be open, the gap between the body portions 51, 52 may be a few centimeters. The interior space of the suitcase 5 is accessible. Upon pulling the cover element 110 back to the base element 113, the suitcase 5 closes completely. Engagement section 1130 engages into the engagement element 10. The cover element 110 may then still be somewhat inclined. In this state, the latch 17 is normally in activation position (if the pin 182 has not been manually pushed before closing). Upon pushing the cover element 110 down into the closed position where it becomes to be arranged substantially parallel to and in contact with the base element 113, the hook element 1197 engages into the recesses 1197 of the bottom plate 119, then into the recess 166 of the push element 16, and then into recess 171 of the latch element 17. Upon contact, the pin 182 is pushed against spring 181, the latch is free to move to initial position through action of biasing member 138 and the hook-element 1137 is caught in latch 17 and the locking device 13 moves to locking position, securing any slider 15 in locking position.

The sliders 15 may also be pushed into the closed buckle element 11 as the slanted bolt surface 120 allows that the slider 15 pushes the bolt back whereupon the biasing member 138 snaps the bolt 12 into engagement after the engagement section 150 is in place.

It is to be noted that in both, the first and second embodiment, the zipper sliders 15 may be released without opening the cover element 110. Accordingly, the push button 160 of a closed closure device assembly 1 may be pressed and the zipper sliders 15 may be removed without moving the cover element.

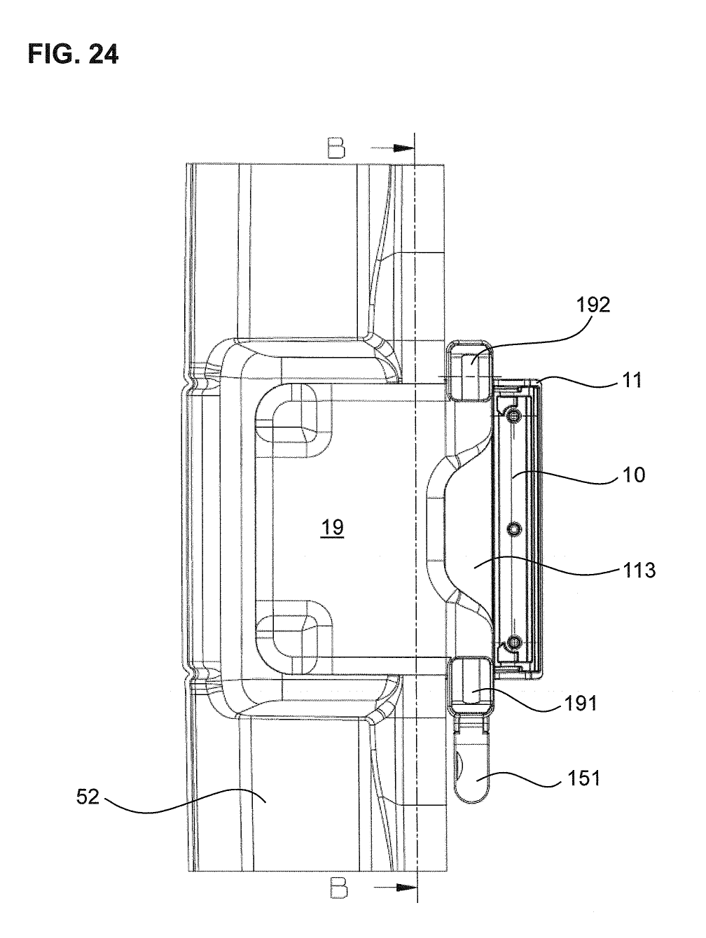

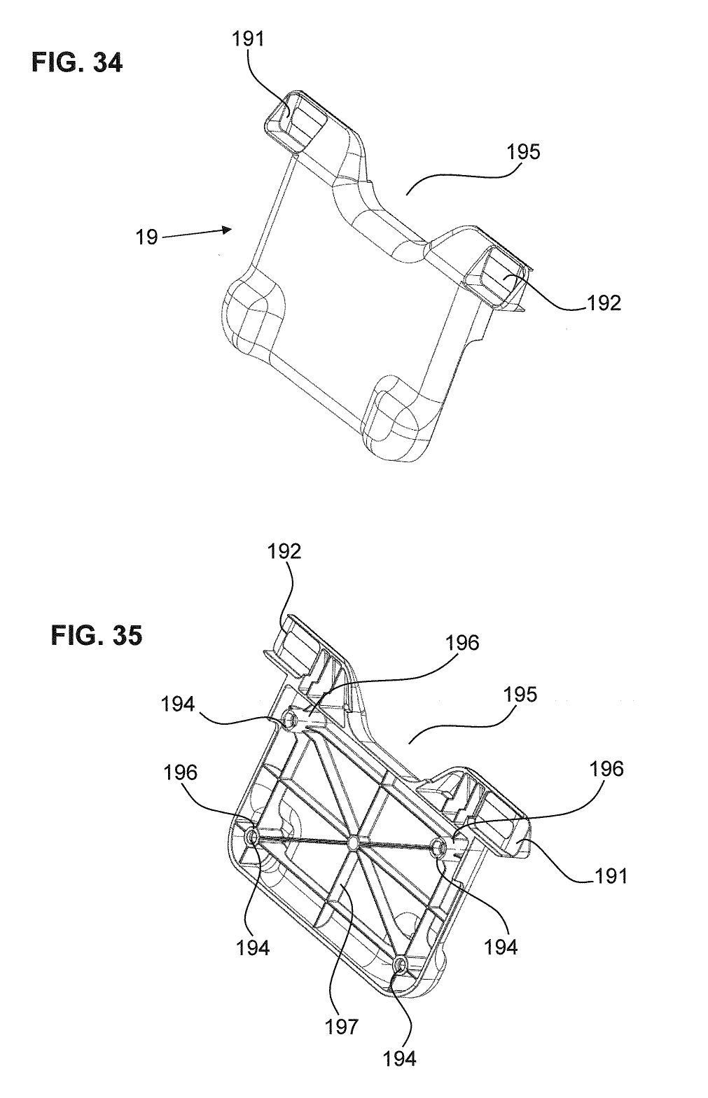

FIG. 24 shows in a view from inside of the suitcase 5 onto the inside wall surface of the second body portion 52. From the inside of the suitcase 5, a counter plate 19 is attached to the base element 113 of the closure device assembly 1. The counter plate 19 extends from the left end of the buckle element 11 in FIG. 24 towards the zipper 60 that is arranged between the first and the second body portions 51, 52. FIG. 24 also shows the engagement element 10 that is to be arranged on the first body portion 51 (not shown) and that is contacted by the buckle element 11. The counter plate 19 is fixedly and directly attached, preferably but not necessarily by means of a screw connection, to the base element 113. The counter plate provides first and second support protrusions 191, 192 that extend along and inwardly with respect to the zipper 60 and support zipper sliders 15 that are in engagement position (cf. FIGS. 34, 35 and text below).

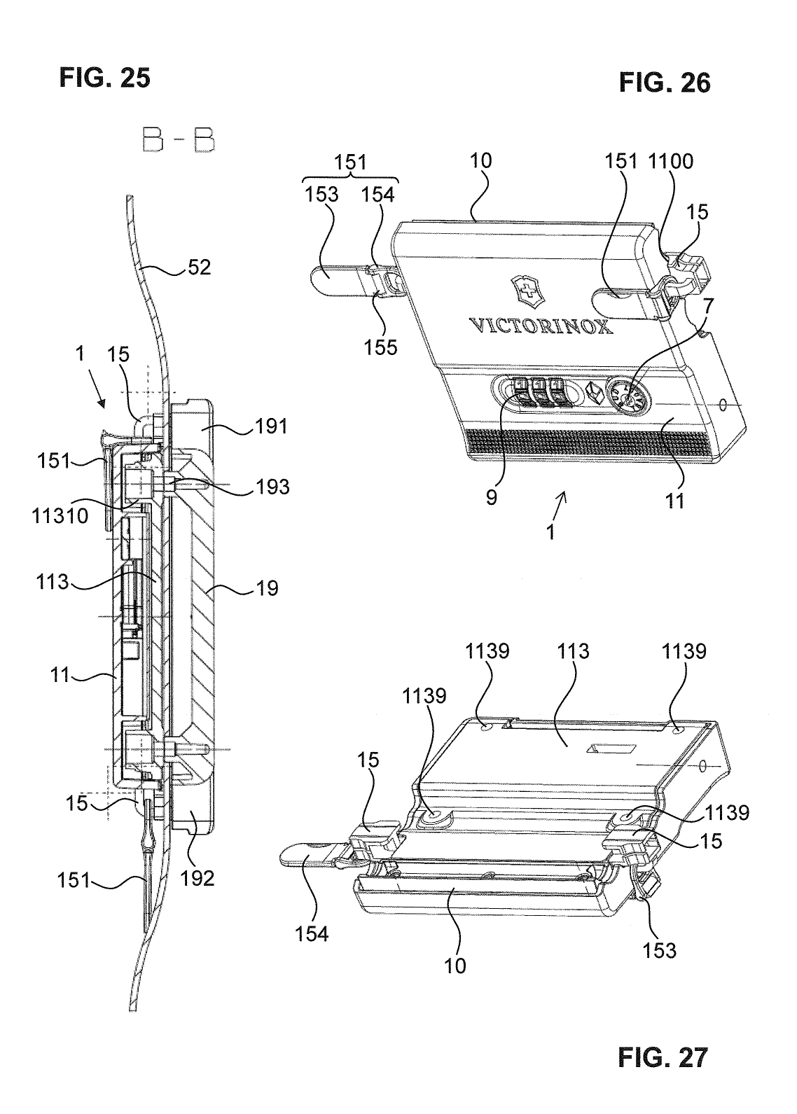

FIG. 25 shows a cross-section B-B as indicated in FIG. 24 through the closure device assembly 1 according to FIG. 24. One can see from FIG. 25 that the counter plate 19 is directly screwed by means of screws 193 to that base element 113 of the closure device assembly 1. Moreover, FIG. 25 shows two zipper sliders 15 with zipper pull elements 151.

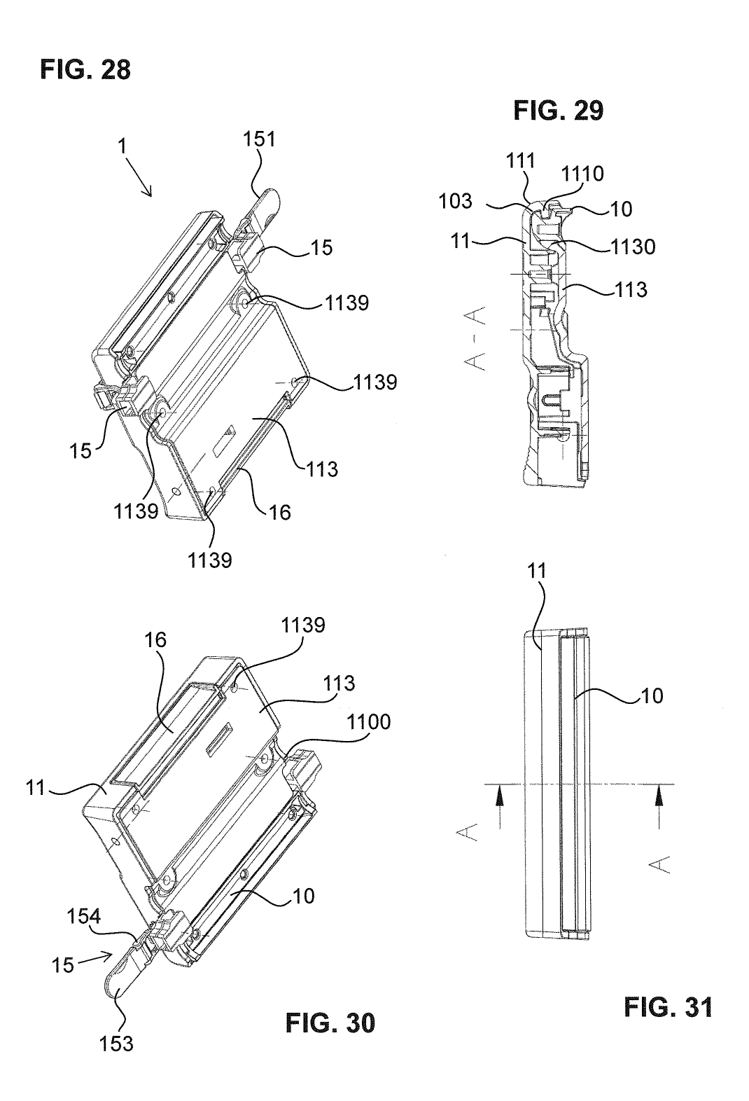

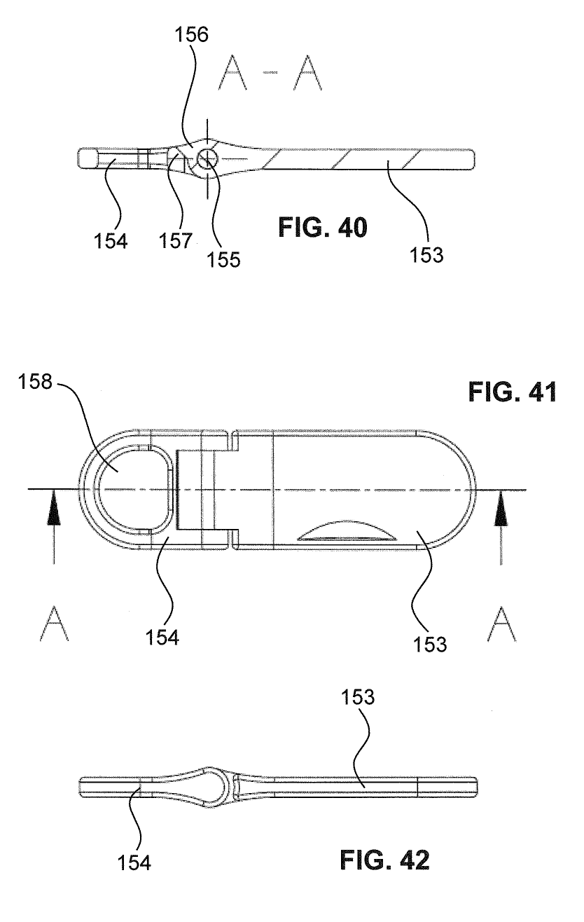

Moreover, FIGS. 25 to 30 show a second embodiment of the zipper sliders 15 for the zipper 60. As can be seen from FIGS. 25 and 26, the pull element 151 is designed in a two-part manner, wherein the two parts 153, 154 are hinged to one another by means of a hinge 155. The first and the second part 153, 154 are designed such that the two parts 153, 154 have a well-defined stop position when they are aligned to extend within the same plane as shown for the left slider 15 in the FIGS. 26, 27, while the second part 154 is free to rotate by about 90° about the hinge 155 relative to the first part 153 as shown for the right slider 15 in the FIGS. 26, 27 (cf. also FIGS. 41 to 45 and text below). This zipper slider design is advantageous as it avoids that the zipper handle 151 is used as a lever to move the slider 15 out of engagement with the bolt 12 when the closure device assembly 1 is closed. Moreover, it allows in its straight or flat configuration to be conveniently push the pull tab 151 and thereby to insert the zipper slider 15 into recess 1100 of the buckle element 11 such that its engagement section 150 is brought into engagement with the bolt 12.

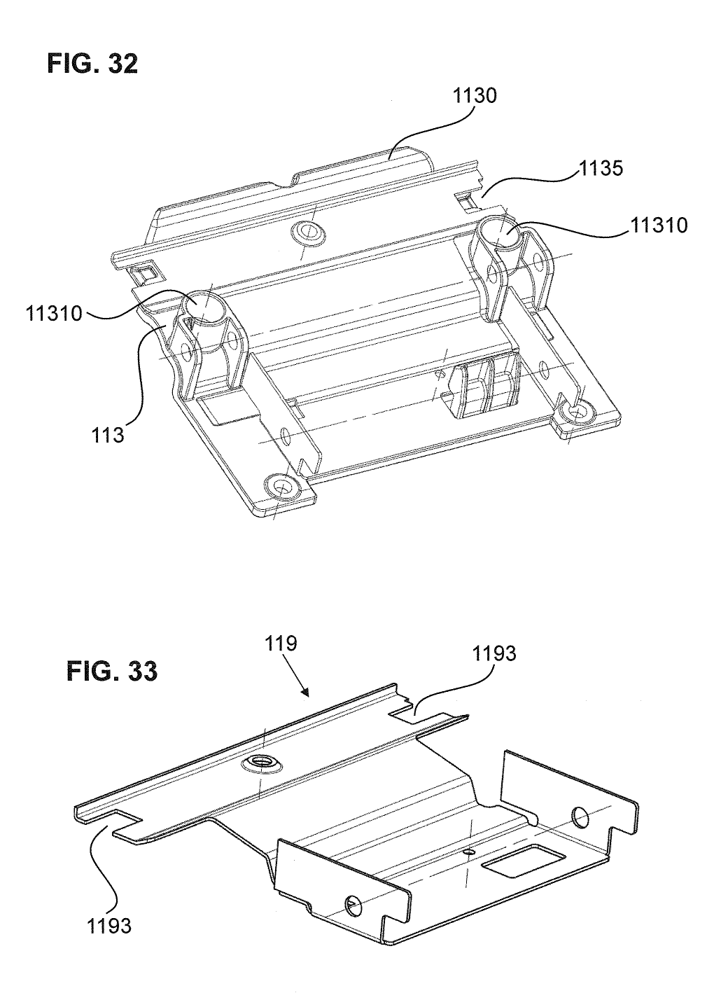

FIGS. 27, 28, and 30 show the closure device assembly 1 in perspective views onto the base element 113. FIGS. 27, 28, and 30 show the zipper sliders 15 with double layer coil zipper design arranged in the closed position. Moreover, these figures show the bottom part of the base element 113 where one can see recesses 1139 into which the screws 193 (cf. FIG. 25) engage in order to directly attach the counter plate 19 and the base element 113. Heads of the screws 193 are received in domes 11310 arranged on the base element 113 (cf. FIG. 32) the screw bolts then extend through the domes 11310 and through the base element 113 into threaded receptions 194 arranged on the counter plate 19 (cf. FIGS. 25 and 35).

The base element 113 in the embodiment according to FIG. 10 is providing threaded recesses 1136 to receive a bolt of a screw that is inserted into the closure device assembly from inside the suitcase 5. The screw heads have then to be covered by a cap such that they are not exposed to the inner volume of the suitcase 5. In the embodiment of the closure device assembly 1 shown in FIG. 24 et seq., the screws 193 are inserted from the outside of the suitcase 5, the heads are received in the domes 11310 in the closure device 1. According to this design, no part of the screw is exposed such that capping would be required.

Preferably, the material that forms the second body portion 52, e.g. polycarbonate, is recessed such that the counter plate 19 may directly contact, with its cylinders 196 with recesses 194, the base element 113. Accordingly, the counter plate 19 is fixedly connected to the base element 113 which gives a compact and secure closure device assembly 1.

In order to adapt for changing wall thicknesses of different suitcase models, preferably elastic layer materials may be placed between the wall parts of the suitcase 5 and the closure device assembly 1.

FIG. 29 shows a cross-section according to FIG. 31 through the closure device assembly 1 according to the FIGS. 26 to 28. From FIG. 29 it is apparent that the engagement element 10 is trapped between the base element 13 and the buckle element 11. The base element 113 contacts that engagement element 10 with its engagement section 1130 while the first engagement portion 111 contacts the engagement element 10 from the other side and protrudes with its engagement web 1110 into the engagement groove 103 of the engagement element 10. Thereby the engagement element 10 is securely trapped between the base element 113 and the buckle element 11 when the closure device assembly 1 is closed; the engagement section 10 cannot be pushed down into the suitcase 5 for disengagement.

FIG. 32 shows the base element 113 in isolation. One can see the domes 11310 that are arranged on the top side of the base element 113. The domes 11310 are designed to receive the heads of screws 193, while threaded bolts of the screws 193 are engaged deeply into the counter plate 19 as shown in the cross-sectional view of FIG. 25.

Moreover, FIG. 32 shows that the recesses 1135 are adapted for receiving the slider 15 of the double layer coil zipper 60.

FIG. 33 shows the bottom plate 119 wherein this bottom plate 119 is the substantially the same as shown in FIG. 12 except for the recesses 1193 that are fitted for the different geometry of the slider of the double layer coil zipper.

FIGS. 34 and 35 show the counter plate 19 in isolation and in a perspective view from the bottom and the top, respectively. The plate-like element has rounded corner regions and a half-shell design. The first and second support protrusions 191, 192 are visible. They extend to either side from the corner regions at the distal edge of the counter plate 19, while a region between the support portions 191, 192 is recessed with recess 195.

These first and second support protrusions 191, 192 are designed such that, when the sliders 15 are in closed position, the sliders 15 are guided from below by the support protrusions 191, 192. If, for example, one is closing the buckle element 11 while the sliders 15 are in closed position, the buckle element 11 exerts a downward force onto the sliders 15 via its bolts 12. The support protrusions 191, 192 then avoid that the sliders 15 move downward and away from the bolts 12. Therefore, the support protrusions 191, 192 ensure that the bolts 12 engage into the engagement sections 150 of the sliders 15 for properly closing the closure device assembly 1.

Moreover, FIG. 35 shows the receptions 194 formed into the cylinders 196 for receiving the screws 193 that are placed in the domes 11310 of the base element. The second body portion 52 has respective recesses (not shown) such that the cylinders 196 can directly contact the bottom surface of the base element 113. This allows for a safe and strong contact between the counter plate 19 and the base element 113. FIG. 35 also shows a plurality of ribs or webs 197 that are arranged on the top side of the counter plate 19 and help to stabilize the cylinders 196 and make the counter plate 19 more sturdy and stable.

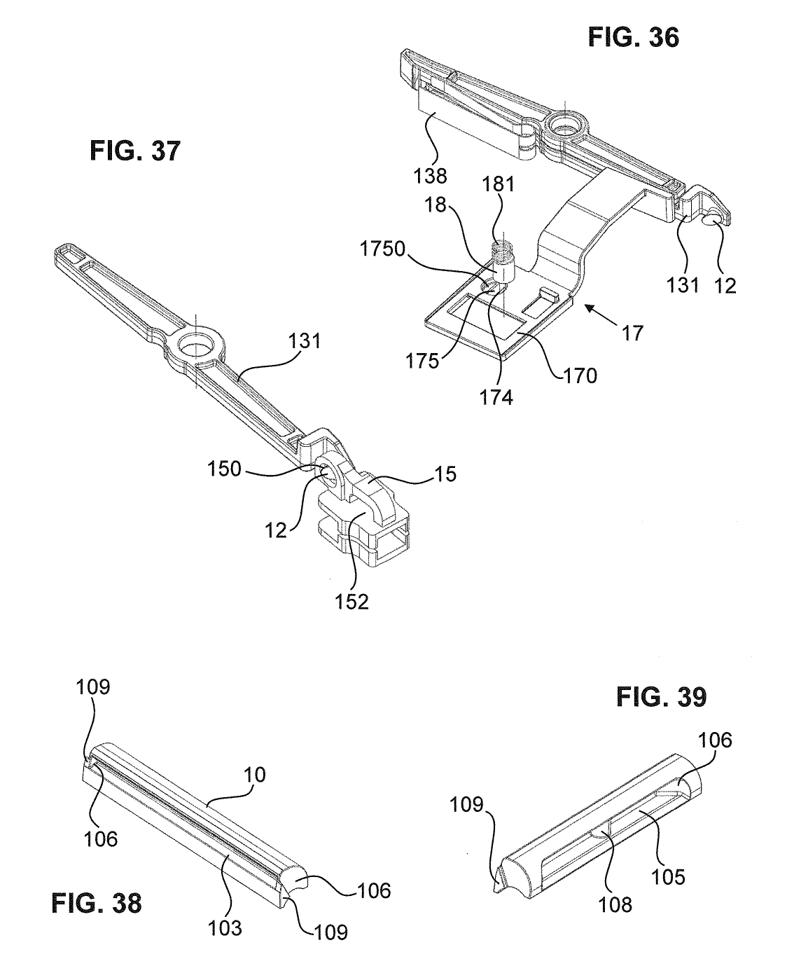

FIG. 36 shows the lock bolt 18 with its biasing member 181 and the latch element 17 in engagement with the lever 131. The lock bolt 18 is arranged above the recess 174 with the smaller through hole 175 limited by the stop surfaces 1750 arranged in the recess 174 for stopping the lock bolt 18 from exiting through the recess. The through hole 175 allows pressing the lock bolt 18 from the bottom surface of the base element 113 against the biasing member 181 for its disengagement out of the recess 174.

FIG. 37 shows, like FIG. 18, the slider 15 in engagement with the bolt 12, wherein the slider 15 is a slider of a double layer coil zipper.

FIGS. 38 and 39 show the engagement element 10 with additional ramp elements 109 arranged on the outside of the side walls 106. These ramp elements 109 have inclined surfaces that guide the buckle element 11, during its releasing toggle-clamp movement when opening the closed assembly 1, to ensure that the upward movement of the buckle element 11 is strong enough. This avoids that the buckle element 11 runs against a suitcase handle that may be place in front of the buckle element 11.

FIGS. 40 to 42 show the zipper pull element 151 in its well-defined stop position defining the flat configuration, wherein the first and second part 153, 154 are aligned and extend within the same plane. FIG. 40 shows a cross-section, displaying the hinge axle 155. The first part 153 of the puller 151 has a hinge-side stop protrusion or notch 156 that stops against a stop surface 157 arranged on the second part of the second part 154 of the puller 151 to define the well-defined stop position. This allows pushing with the thumb the flat pull element 151 thereby inserting the slider 15 into recess 1100 for engagement with the bolt 12.

From the FIGS. 40 to 45 it is also apparent that the second part 154 has a recess 158 with which it engages the slider attachment portion 152.

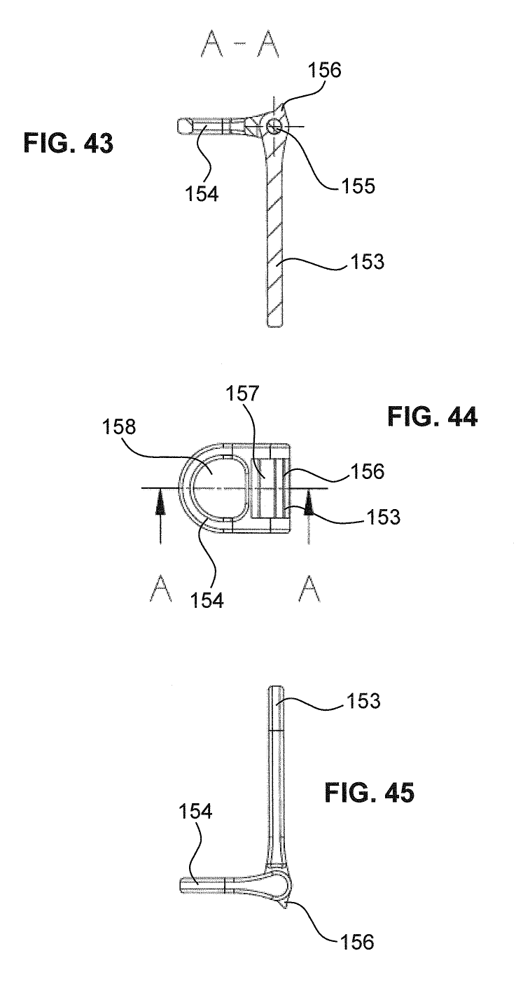

FIGS. 43 to 45 show the zipper puller 151 in a second stop position, wherein the first and second parts 153, 154 form a knee-like configuration with an angle of 90°. The angle may also be larger.

Generally, it is preferred to use a zipper 60 of double layer coil zipper design as this further increases the security of the piece of luggage. Moreover, a pull tab design according to FIGS. 40 to 45 is preferred as it avoids the risk to use the tab 151 for levering the slider 15 out of engagement with the bolt 12 while allowing to push the flat pull tab 151 for inserting the slider 15 into the recess 1100.

LIST OF REFERENCE SIGNS

| | |
|---|---|
| 1 | closure device assembly |
| 10 | engagement element |
| 101 | base element of 10 |
| 102 | second engagement portion |
| | of 10 |
| 103 | front groove |
| 104 | overlap |
| 105 | back slot |
| 106 | side wall |
| 107 | connection hole |
| 108 | cylinder |
| 109 | ramp element |
| 11 | buckle element |
| 110 | cover element |
| 1100 | recess in 1102 for 15 and 60 |
| 1101 | cover plate |
| 1102 | side wall |
| 1103 | recess in 1102 for 16 |
| 1104 | reception structure for 9 |
| 1105 | pin |
| 1106 | hollow cylinder for 7 |
| 1107 | bolt connection cylinder |
| 1108 | cylinder guide for 18 |
| 1109 | reception |
| 111 | first engagement portion of |
| | 11 |
| 1110 | engagement web |
| 112 | connecting element |
| 1121 | first lever arm of 112 |
| 1122 | second lever arm of 112 |
| 1123 | connector element |
| 113 | base element of 11 |
| 1130 | engagement section of 113 |
| 1131 | first section of 113 |
| 1132 | second section of 113 |
| 1133 | third section of 113 |
| 1134 | recess for 108 |
| 1135 | recess for 15 in 1131 |
| 11350 | groove |
| 1136 | receiving section of a bolt |
| | connection |
| 1137 | hook element on 1133 |
| 1138 | undercut in 1137 |
| 1139 | recesses |
| 11310 | dome |
| 114 | hinge portion |
| 115 | guide element |
| 116 | locking pin |
| 1160 | recess in 116 |
| 117 | spring |
| 118, 1180 | axle |
| 119 | bottom plate |
| 1190 | first section of 119 |
| 1191 | second section of 119 |
| 1192 | third section of 119 |
| 1193 | slot in 1190 |
| 1194 | through hole in 1190 |
| 1195 | side wall of 1192 |
| 1196 | through hole in 1195 |
| 1197 | recess in 1192 |
| 1198 | through hole 1192 |
| 1199 | screw (FIG. 12) |
| 12 | bolt |
| 120 | slanted bolt tip surface |
| 13 | locking device |
| 130 | bolt biasing member |
| 131 | first bolt lever arm |
| 1310 | recess |
| 1311 | through hole |
| 132 | second bolt lever arm |
| 1320 | recess |
| 1321 | through hole |
| 133 | head portion of 131 |
| 134 | head portion of 132 |
| 135 | slanted contact surface of 133 |
| 136 | slanted contact surface of 134 |
| 138 | biasing member |
| 1381 | first contact tongue |
| 1382 | second contact tongue |
| 1383 | mounting tongue |
| 1384 | loop |
| 14 | actuation device |
| 140 | actuation biasing member |
| 1400 | pin for 140 |
| 141 | first actuation lever arm |
| 142 | second actuation lever arm |
| 143 | head portion of 141 |
| 144 | head portion of 142 |
| 145 | slanted contact surface of 143 |
| 146 | slanted contact surface of 144 |
| 147 | pivot joint |
| 15 | zipper slider for 60 |
| 150 | engagement section of 15 |
| 151 | pull element of 15 |
| 152 | attachment portion for 151 |
| 153 | first part of 151 |
| 154 | second part of 151 |
| 155 | hinge axle |
| 156 | hinge-side stop protrusion of |
| | 153 |
| 157 | stop surface for 156 on 154 |
| 158 | recess |
| 16 | push element |
| 160 | push button |
| 162 | contact element |
| 163 | guide pin |
| 164 | recess for 116 |
| 165 | biasing member on 163 |
| 166 | recess |
| 167 | guide structure |
| 168 | recess |
| 169 | side wall |
| 169 | longitudinal hole |
| 17 | latch element |
| 170 | base plate of 17 |
| 171 | recess for 1137 |
| 172 | recess for 7 |
| 173 | stop web |
| 174 | recess for 18 |
| 175 | through hole in 174 |
| 1750 | stop surface in 174 |
| 176 | slot in 174 |
| 177 | connecting portion of 17 |
| 179 | inclined contact portion of 17 |
| 1790 | inclined contact surface of |
| | 179 |
| 18 | lock bolt |
| 181 | biasing member for 18 |
| 182 | pin on 18 |
| 19 | counter plate |
| 191 | first support protrusion |
| 192 | second support protrusion |
| 193 | screw |
| 194 | reception |
| 195 | recess |
| 196 | cylinder |
| 197 | web |
| 5 | suitcase |
| 50 | interior space of 5 |
| 51 | first body portion of 5 |
| 510 | edge of 51 |
| 52 | second body portion of 5 |
| 520 | edge of 52 |
| 53 | front wall of 5 |
| 54 | back wall of 5 |
| 55 | top wall of 5 |
| 56 | bottom wall of 5 |
| 57 | first side wall of 5 |
| 58 | second side wall of 5 |
| 59 | handle |
| 590 | handle recess |
| 60 | zipper |
| 7 | TSA lock |
| 71 | sledge of 7 |
| 710 | ramp of 71 |
| 72 | recess in 72 |
| 73 | locking cylinder |
| 74 | distal pin |
| 8 | gap |
| 9 | lock |
| 91 | recess for 163 |
| 92 | number wheels |
| 93 | blocking element for 163 |

1. A closure device assembly for a piece of luggage, the piece of luggage including a first body portion, a second body portion, and a zipper, said zipper being arranged between said first and second body portions, the closure device assembly comprising:
at least one engagement element adapted for arrangement on said first body portion;
at least one buckle element adapted for arrangement on said second body portion, said buckle element being adapted for pivotal motion between an open position and an engagement position such that, in said engagement position, said buckle element is in contact with said engagement element, said pivotal motion being about an axis that extends substantially parallel to said zipper, and
at least one zipper slider adapted for operation of said zipper and including at least one engagement section for engagement with said engagement element or said buckle element;
wherein the closure device assembly further comprises:
a locking device for locking said engagement section of said zipper slider when said zipper slider is in a closed position;
wherein said buckle element comprises a cover element and is adapted to cover in a closed positon of the closure device assembly with said cover element at least part of the locking device and said engagement section of the zipper slider in said closed position.

2. The closure device assembly according to claim 1, wherein the engagement section is integrally formed onto the zipper slider.

3. The closure device assembly according to claim 1, wherein the locking device comprises:
at least one bolt adapted for releasably locking said zipper slider;
a bolt biasing member being attached to and biasing said bolt; wherein said bolt is moveable between
a locking position, in which said bolt engages with an engagement section of the zipper slider for locking said zipper slider, when said zipper slider is in the closed position; and
a release position, in which said zipper slider in said closed position is released,
wherein said buckle element is adapted to cover, in said engagement position, with said cover element at least said bolt and said engagement section of said zipper slider in said closed position.

4. The closure device assembly according to claim 3, wherein said bolt biasing member biases said bolt in said release position or wherein said bolt and said bolt biasing member are attached to said engagement element or wherein said bolt and said bolt biasing member are attached to said buckle element.

5. The closure device assembly according to claim 3, wherein said bolt is arranged on a pivotable bolt lever arm, wherein said bolt biasing member biases said bolt lever arm.

6. The closure device assembly according to claim 4, further comprising an actuation device, wherein said actuation device is adapted for moving said bolt against said bolt biasing member from said release position into said locking position upon closing the closure device assembly.

7. The closure device assembly according to claim 6, wherein said actuation device is attached to said buckle element.

8. The closure device assembly according to claim 6, wherein said actuation device comprises an actuation biasing member, said actuation biasing member biasing said actuation device in an actuation position such that, upon closing the closure device assembly, said actuation biasing member overrides said bolt biasing member and pushes said bolt from said release position into said locking position, and wherein said actuation device is adapted for being moved against said actuation biasing member from said actuation position to an initial position.

9. The closure device assembly according to claim 1, wherein said buckle element has a first engagement portion and said engagement element has a second engagement portion, said first and second engagement portions being adapted for mutual engagement.

10. The closure device assembly according to claim 9, wherein said buckle element is designed as a toggle clamp adapted for clamping said first and second body portions to one another.

11. The closure device assembly according to claim 3, comprising a push element for moving said bolt from said locking position into said release position wherein the engagement section may be released by pushing the push element without opening the cover element.

12. The closure device assembly according to claim 10, wherein said push element is a push button arranged on said buckle element, or wherein the closed closure device assembly is adapted for moving said actuation device from said actuation position into said initial position by means of pushing the push element, whereupon said bolt is moved from said locking position into said release position.

13. The closure device assembly according to claim 5, comprising a push element for moving said bolt from said locking position into said release position or wherein the engagement section may be released by pushing the push element without opening the cover element, wherein said push element is adapted to push, upon pushing on said push element, onto said bolt-lever arm to bring it into release position.

14. The closure device assembly according to claim 3, wherein at least one of said bolt and said engagement section of said zipper slider are/is formed such that said zipper slider that is moved to close said piece of luggage pushes said bolt into said release position.

15. The closure device assembly according to claim 1 comprising at least or exactly two zipper sliders working in opposite directions on said zipper, wherein, said closure device assembly comprises at least or exactly one bolt for each zipper slider, or wherein at least one of the locking device and the actuation device comprise two single-lever arms.

16. The closure device assembly according to claim 1, further comprising a counter plate with at least one support portion, wherein the counter plate is arranged and designed such that the support portion supports the zipper slider in closed position against force applied through the cover element onto the zipper slider.

17. The closure device assembly according to claim 1, wherein the zipper slider comprises a pull element, wherein the pull element comprises two parts that are hinged to one another, and wherein the pull element is designed such that the first and second parts are pivotable with respect to one another from a flat configuration to only one side into an angled configuration.

18. The closure device assembly according to claim 17, wherein, in the angle configuration, an angle between the first and second part is 90° or more.

19. The closure device assembly according to claim 1, wherein the zipper is a double layer coil zipper.

20. The closure device assembly according to claim 1, wherein the engagement element comprises at least one ramp element with an inclined surface for guiding a releasing movement of the cover element.

21. A piece of luggage comprising:
a first body portion,
a second body portion, and
a zipper, said zipper being arranged between said first and second body portions,
the piece of luggage comprising a closure device assembly according to claim 1, wherein said at least one engagement element is arranged on said first body portion and said at least one buckle element is arranged on said second body portion.
